(19) United States
(12) Patent Application Publication
(10) Pub. No.: US 2025/0107968 A1
(43) Pub. Date: Apr. 3, 2025

(54) MEDICATION SUPPORT DEVICE

(71) Applicants: Takato Mochizuki, Kanagawa (JP); Hirotaka Hayashi, Kanagawa (JP); Terumitsu Azuma, Kanagawa (JP); Manabu Yamanaka, Kanagawa (JP); Yoshihide Sugiyama, Kanagawa (JP); Hiroshi Fujie, Kanagawa (JP); Youhei Niitsuma, Kanagawa (JP); Yu Yamaya, Kanagawa (JP)

(72) Inventors: Takato Mochizuki, Kanagawa (JP); Hirotaka Hayashi, Kanagawa (JP); Terumitsu Azuma, Kanagawa (JP); Manabu Yamanaka, Kanagawa (JP); Yoshihide Sugiyama, Kanagawa (JP); Hiroshi Fujie, Kanagawa (JP); Youhei Niitsuma, Kanagawa (JP); Yu Yamaya, Kanagawa (JP)

(73) Assignee: Ricoh Company, Ltd., Tokyo (JP)

(21) Appl. No.: 18/892,733

(22) Filed: Sep. 23, 2024

(30) Foreign Application Priority Data
Sep. 28, 2023 (JP) 2023-168567

(51) Int. Cl. A61J 1/14

(52) U.S. Cl. CPC A61J 1/14

(57) ABSTRACT

A medication support device includes a container that stores a medicine package, a pickup device to pick up the medicine package from the container, a suction device disposed at the pickup device to suck the medicine package in the container by air, a conveyor to convey the medicine package picked up from the container using the suction device, a medicine dispensing container to dispense the medicine package conveyed by the conveyor at a specific one of a plurality of positions partitioned by a plurality of partitions, and a jogger to move the medicine package that has already been dispensed to the medicine dispensing container to a desired position of the medicine dispensing container when the medicine package is dispensed from the container to the medicine dispensing container a plurality of times.

### CROSS-REFERENCE TO RELATED APPLICATION

This patent application is based on and claims priority pursuant to 35 U.S.C. § 119 (a) to Japanese Patent Application No. 2023-168567, filed on Sep. 28, 2023, in the Japan Patent Office, the entire disclosure of which is hereby incorporated by reference herein.

### BACKGROUND

### Technical Field

The present disclosure relates to a medication support device.

### Background Art

For the purpose of reducing the time or labor of medication of patients who take medicines or medication assistants, some technologies for medication support devices using two or more actuators have been proposed to pick up a medicine pack from a container, which stores medicine packs and is referred to as a cartridge, and convey and dispense the picked-up medicine pack.

### SUMMARY

The present disclosure described herein provides a medication support device including a container that stores a medicine package, a pickup device to pick up the medicine package from the container, a suction device disposed at the pickup device to suck the medicine package in the container by air, a conveyor to convey the medicine package picked up from the container using the suction device, a medicine dispensing container to dispense the medicine package conveyed by the conveyor at a specific one of a plurality of positions partitioned by a plurality of partitions, and a jogger to move the medicine package that has already been dispensed to the medicine dispensing container to a desired position of the medicine dispensing container when the medicine package is dispensed from the container to the medicine dispensing container a plurality of times.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1A is a schematic front view of a medication support device in its entirety, according to a first comparative example.

FIG. 1B is a side view of the medication support device of FIG. 1A.

FIG. 2A is a plan view of a single medicine package.

FIG. 2B is a side view of the single medicine package of FIG. 2A viewed in a direction indicated by an arrow A.

FIG. 2C is a side view of the single medicine package of FIG. 2A viewed in a direction indicated by an arrow B.

FIG. 2D is a is a diagram illustrating a typical form of continuous packs.

FIG. 3 is an external perspective view of a medicine dispensing tray, illustrating one configuration of the medicine dispensing tray.

FIG. 4A is a vertical sectional view of a storage unit.

FIG. 4B is a bottom view of the storage unit of FIG. 4A.

FIG. 5 is a schematic plan sectional view of the attaching and detaching mechanisms for a storage unit, which are arranged on a drawer.

FIG. 6 is a schematic plan view of containers and illustrates the mechanisms for recognizing each one of the containers, which are arranged in a drawer.

FIG. 7A is a front view of a pickup unit according to a first comparative example, illustrating a configuration or structure of the pickup unit.

FIG. 7B is a plan view of the pickup unit of FIG. 7A.

FIG. 8 is a magnified view of a guide unit and a guide groove of the pickup unit of FIG. 7A.

FIG. 9A to FIG. 9C are front views of a pickup unit according to the first comparative example, illustrating the progression of the operation of the pickup unit.

FIG. 10A and FIG. 10B are front views of a pickup unit according to the first comparative example, illustrating the progression of the operation of the pickup unit, following FIG. 9A to FIG. 9C.

FIG. 11A and FIG. 11B are front views of a pickup unit according to the first comparative example, illustrating the progression of the operation of the pickup unit, following FIG. 10A and FIG. 10B.

FIG. 12A to FIG. 12C are supplemental diagrams illustrating how a pickup unit according to the first comparative example can suck and hold a medicine package at the bottom of a container as desired.

FIG. 13A is a front view of a conveyor illustrating a schematic configuration of the conveyor.

FIG. 13B is a side view of the conveyor of FIG. 13A.

FIG. 14 is a perspective view of a Y-guide unit illustrating how a front end of the Y-guide unit is held in a conveyor.

FIG. 15 is a diagram illustrating the control blocks of a medication support device according to a first comparative example.

FIG. 16A to FIG. 16C are diagrams illustrating an operation in which medicine packages are dispensed to subdivision boxes of a medicine dispensing tray in a medication support device according to the first comparative example.

FIG. 17A and FIG. 17B are diagrams illustrating the operation performed in a medication support device according to a first comparative example.

FIG. 18A and FIG. 18B are flowcharts of the operation of a pickup unit according to the first comparative example.

FIG. 19A is a front view of a pickup unit according to a second comparative example, illustrating a configuration or structure of the pickup unit.

FIG. 19B is a plan view of the pickup unit of FIG. 19A.

FIG. 20 is a diagram illustrating the control blocks of a medication support device according to a second comparative example.

FIG. 21A and FIG. 21B are flowcharts of the operation of a pickup unit according to the second comparative example.

FIG. 22A is a side view of a pickup unit illustrating a configuration and operation to dispense packs to a subdivision box and align the dispensed pack therein using a jogger mechanism according to an embodiment.

FIG. 22B to FIG. 22D are front views of a pickup unit, illustrating the progression of the operation to dispense a pack to a subdivision box and align the dispensed pack therein using a jogger mechanism.

FIG. 23A is a side view of a pickup unit, illustrating the operation performed subsequent to FIG. 22D to dispense a pack to a subdivision box and align the dispensed pack therein using a jogger mechanism.

FIG. 23B to FIG. 23D are front views of a pickup unit, illustrating the progression of the operation to dispense a pack to a subdivision box and align the dispensed pack therein using the jogger mechanism of FIG. 23A.

FIG. 24A to FIG. 24D are magnified front views of a pickup unit, which correspond to FIG. 22B to FIG. 22D, illustrating the progression of the operation of a suction device and a jogger mechanism.

FIG. 25A to FIG. 25D are magnified front views of a pickup unit, which correspond to FIG. 23B to FIG. 23D, illustrating the progression of the operation of a suction device and a jogger mechanism.

FIG. 26A to FIG. 26C are front views of a pickup unit according to an embodiment, illustrating the progression of the operation of the pickup unit.

FIG. 27A and FIG. 27B are front views of a pickup unit according to the first embodiment, illustrating the progression of the operation of the pickup unit, following FIG. 26A and FIG. 26C.

FIG. 28A and FIG. 28B are front views of a pickup unit according to the first embodiment, illustrating the progression of the operation of the pickup unit, following FIG. 27A and FIG. 27B.

FIG. 29A and FIG. 29B are flowcharts of the operation performed by a pickup unit and a jogger mechanism according to an embodiment.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to limit the present disclosure. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing embodiments illustrated in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

Embodiments of the present disclosure and examples of the present disclosure are described below in detail with reference to the accompanying drawings. In the drawings and the description of comparative examples, or the embodiments and examples of the present disclosure, like reference signs denote like elements such as members or components of similar shapes or similar functionality, and overlapping description may be omitted where appropriate unless there is concern about the possibility of confusion.

### First Comparative Example

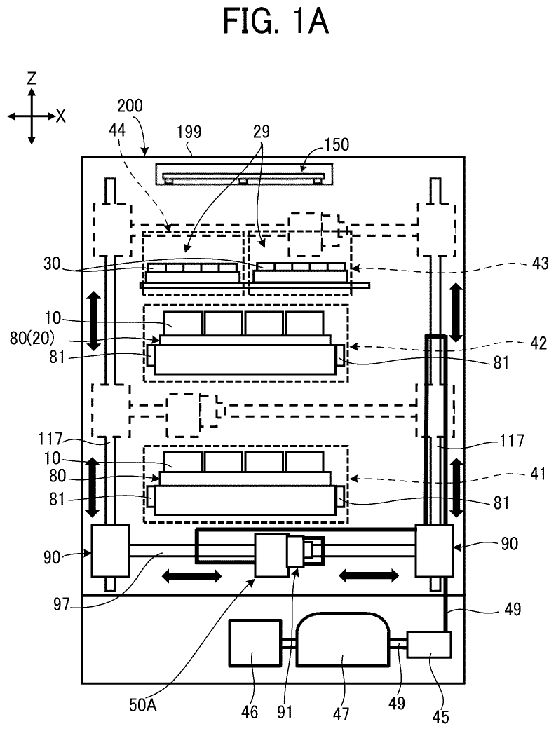

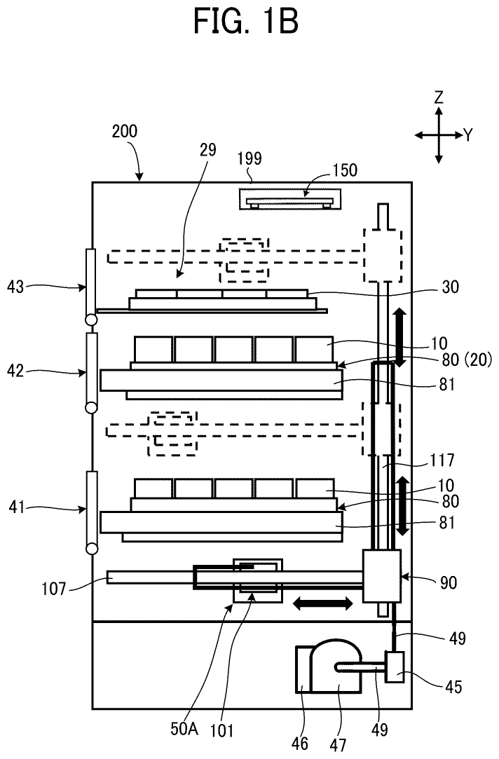

A basic and overall configuration or structure of a medication support device 200 according to a first comparative example is described with reference to FIG. 1A and FIG. 1B.

FIG. 1A is a front view of the medication support device 200 in its entirety, according to the first comparative example.

FIG. 1B is a schematic side view of the medication support device 200 of FIG. 1A.

As illustrated in FIG. 1A and FIG. 1B, the medication support device 200 is provided with containers 10, container trays 20, drawers 80, medicine dispensing trays 30, a pickup unit 50A, a conveyor 90, and a first gate 41 to a fourth gate 44. In FIG. 1A and FIG. 1B, the horizontal direction or the right and left directions of the medication support device 200 is defined as an X-axis direction, where the horizontal direction or the right and left directions of the medication support device 200 is also referred to as the width direction of the medication support device 200. Moreover, the front-rear direction or the depth direction of the medication support device 200 is defined as a Y-axis direction, and the up and down directions or the orthogonal direction of the medication support device 200 is defined as a Z-axis direction, where the up and down directions or the orthogonal direction of the medication support device 200 is also referred to as the vertical direction. The same applies to the other drawings given below.

Each one of the containers 10 serves as a first container in which, for example, medicine packages 2 packing a several kinds of medicines 3 or bound medicine packages, as will be described later, are stored upon being stacked on top of each other in layers. The medicine package 2 may be referred to simply as a pack or a medicine pack in the following description. The multiple containers 10 are arranged at a middle portion and a lower portion of the housing 199 of the medication support device 200 through the container tray 20. The multiple containers 10 are attachable to and detachable from the container tray 20 that serves as a second container. The expression “stored upon being stacked on top of each other in layers” in the present disclosure indicates keeping the packs horizontally in such a manner that the front face is viewable.

As will be described later in detail, the container tray 20 can store containers 10 upon positioning those cartridges as desired. The container tray 20 serves as a second container in which at least one of the multiple containers 10 is placed and held.

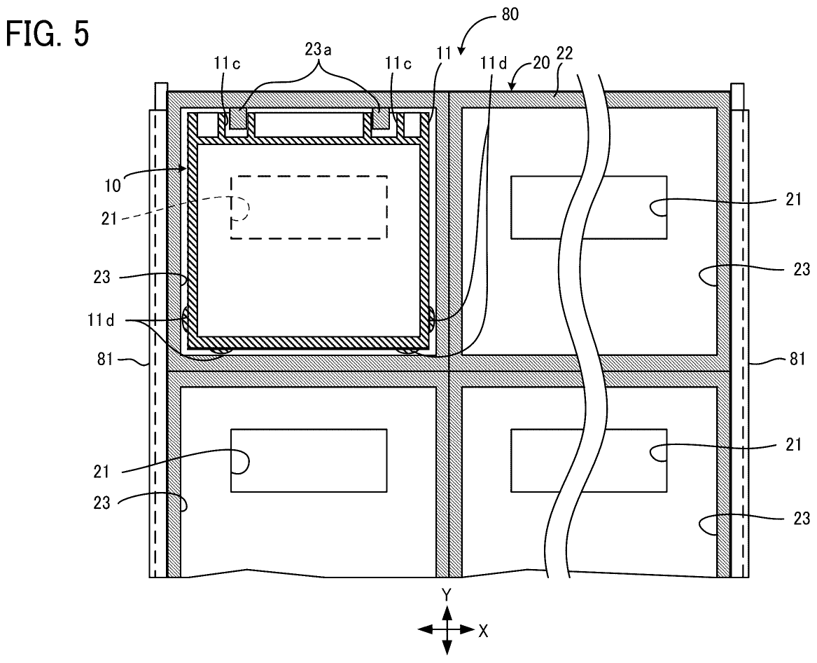

The containers 10 are placed in the pair of drawers 80 through the container tray 20. One of the pair of drawers 80 is arranged at a lower area of the housing 199 of the medication support device 200, and the other one of the pair of drawers 80 is arranged at a middle area of the housing 199 of the medication support device 200. In the case of the medication support device 200 as illustrated in FIG. 1A and FIG. 1B, twenty containers 10 (4×5=20) are placed and held in one container tray 20 of one of the pair of drawers 80, as will be described later in detail with reference to FIG. 5. For the sake of explanatory convenience, each one of the multiple drawers 80 may be referred to as the container tray 20 in the following description.

Each of the multiple containers 10 is placed and housed in a partitioned lattice-like side wall and bottom wall in the container tray 20. On the bottom wall of the container tray 20 of the corresponding ones of the multiple containers 10, a rectangular through opening 21 through which a pack can be picked up from below one of the multiple containers 10, making use of the elasticity or free deformation of the pack as will be described later in detail in relation to the operation, is formed as will be described later in detail with reference to FIG. 5.

The drawer 80 can align and hold the container trays 20. In other words, a pair of slide rails 81 are attached to the outer side wall of the drawer 80, and a rail of the housing 199 is disposed on the housing 199 so as to be fitted to the slide rails 81 of the drawer 80. Due to such an engagement between the rail of the housing 199 and the slide rail 81, the drawer 80 in which one of the multiple container trays 20 is stored and held can be pulled out from the housing 199.

Each one of the multiple medicine dispensing trays 30 is an example of a medicine dispensing container, medicine dispenser, or medicine dispensing table in which the prescribed packs conveyed by the conveyor 90 are arranged. As illustrated in FIG. 1A and FIG. 1B, a pair of medicine dispensing trays 30 are arranged above the multiple containers 10 mounted on the container tray 20 in the uppermost one of the multiple drawers 80. The position of each one of the multiple medicine dispensing trays 30 where the packs are passed to the medicine dispensing tray 30 for automatic medicine dispensing is referred to as a medicine dispensing position 29 in the following description.

The pickup unit 50A is a pickup unit that picks up a specific one of the medicine packs from the container 10, and is an example of a pickup device. The conveyor 90 is an example of a conveyor that conveys the pack picked up from one of the containers 10 using the pickup unit 50A.

Each one of the first gate 41 and the second gate 42 is an example of an entrance and exit gate for the container, which allows one of the multiple containers 10 and the container tray 20 to enter and exit the housing 199 through the drawer 80. The multiple containers 10 are inserted and set in the housing 199 through each one of the first gate 41 and the second gate 42. The open and close door of one of the first gate 41 and the second gate 42 are opened, and the drawer 80 in which the multiple container trays 20 are aligned is drawn out to the front side. By so doing, the containers 10 or the container trays 20 are attached thereto or detached therefrom.

The third gate 43 and the fourth gate 44 are examples of a pair of entrance and exit gates for the medicine dispenser, which allow the multiple medicine dispensing trays 30 that are arranged in two rows at the uppermost stage of the medication support device 200 to enter and exit the housing 199. The third gate 43 and the fourth gate 44 are arranged such that the packs can be taken out immediately after the packs are set or inserted into the medicine dispensing tray 30. In the medication support device 200, two medicine dispensing trays 30 are arranged as described above, and as will be described later in detail, the medicine dispensing trays 30 are arranged for each time of medication such as a time in the morning, a time in the daytime, a time in the evening, and a time before going to bed. The third gate 43 and the fourth gate 44 for the medicine dispensing tray 30 are also arranged for each one of the medicine dispensing trays 30. Due to such a configuration, another different one of the medicine dispensing trays 30 can be taken out even when the medicine dispersing operation is performed on a particular one of the multiple medicine dispensing trays 30.

The container trays 20 are collectively arranged at two positions in upper and lower layers below the medicine dispensing trays 30 arranged uppermost. However, no limitation is intended thereby, and the container trays 20 may collectively be arranged in an upper layer or lower layer. Depending on the number of persons in the day-care center or nursing home, the container trays 20 may be arranged in three stages.

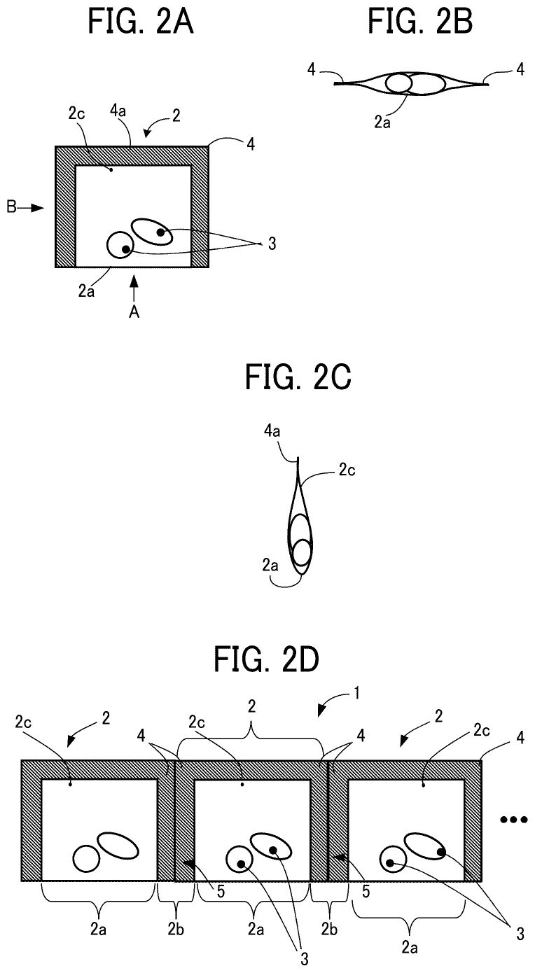

FIG. 2A is a typical plan view of a single medicine package 2.

FIG. 2B a side view of the single medicine package 2 of FIG. 2A viewed in a direction indicated by an arrow A.

FIG. 2C a side view of the single medicine package 2 of FIG. 2A viewed in a direction indicated by an arrow B.

FIG. 2D is a typical plan view of continuous packs 1.

As illustrated in FIG. 2A, one medicine package 2 is formed of, for example, a resin film, and medicines 3 such as capsules or tablets are packed in small quantities. The medicine package 2 includes a bag 2a that covers the medicines 3 and a pressure-bonded portion 4 in which three sides of the bag 2a are pressure-bonded or welded. The pressure-bonded portion 4 is hatched in FIG. 2A and FIG. 2D. Typically, the side of the medicine package 2 on the bag 2a side is folded into two, and the medicines 3 are packed therebetween. The pressure-bonded portion 4 forms a leakage-preventing portion that prevents the medicines 3 from slipping out from the bag 2a. Typically, the medicines 3 in one medicine package 2 is a one-time dosage for a patient who takes medicines.

The medicine package 2 is dispensed and prepared by a drug-dispensing machine installed in, for example, a pharmacy. The dispensing sheets that are used for dispensing the medicines are rolled long-length sheets, and are perforated between packs. The dispensing sheets are rolled in an overlapping manner, and the medicines 3 to be taken are packed in the space between the sheets. The medicines 3 for a required number of doses are divided in small quantities, and packed into the multiple medicine packages 2 that form a continuous sheet. The three sides other than the folded portion of each one of the multiple medicine packages 2 around the medicines 3 for a single dose are sealed in turn by the pressure-bonded portion 4. The multiple medicine packages 2 that form such a continuous sheet may be referred to as continuous packs 1 in the following description. In the continuous packs 1 that are described with reference to FIG. 2D, the multiple medicine packages 2 are coupled to each other and laid like a belt. In the present embodiment described with reference to FIG. 2D, the medicines 3 for three doses are illustrated. The continuous packs 1 are typical form of drug or medicine that is given or sold at a pharmacy or the like to, for example, a user such as a person who actually takes the medicine 3 in the medicine package 2 and a personal care attendant or assistant who helps or assists the user to take medication, or a staff or the like including a pharmacist, a nurse practitioner, a care manager, or a medication assistant of, for example, various kinds of day-care center, nursing home, or medical institution. For the sake of explanatory convenience, each one of the packs is filled with the medicines 3 of the same form in the following description. In FIG. 2C, by way of example, each one of the packs is filled with the same capsule and the same tablets. However, no limitation is indicated thereby. As a matter of course, each one of the packs may be filled with different type of medicines depending on, for example, the usage or purposes of the medication.

In the present embodiment described with reference to FIG. 2A, FIG. 2B, FIG. 2C, and FIG. 2D, the medicine package 2 has a rectangular shape in a plan view, and a packaging method in which three sides are crimped and sealed as in the present embodiment is called three-sided packaging in the related art. Most of the drug-dispensing machines available on the market make the medicine packages 2 using the three-sided packaging.

The pressure-bonded portion 4 has a band-like width of about 10 to 15 millimeters (mm), and has higher rigidity than the portion of the bag 2a that is a transparent or semitransparent film where the medicines 3 can be visually recognized therethrough. A boundary portion 2b that is implemented by perforation 5 is formed in the center of the pressure-bonded portion 4 between a pair of the multiple medicine packages 2 making up the continuous packs 1. The multiple medicine packages 2 are adjacent to each other in an upstream-to-downstream direction. For example, a user who is not handicapped in the hand can obtain one medicine package 2 by tearing off at the perforation 5 by hand or by cutting near the perforation 5 with scissors or a dedicated cutter.

In the case of three-sided packaging as described above, the pressure-bonded three sides cannot leave sufficient thickness or space inside. For this reason, the medicine 3 tends to be concentrated near the bag 2a formed of a film. Accordingly, the medicine package 2 tends to be thick between the turning portion of the film of the bag 2a and a portion near the center. In FIG. 2A, FIG. 2C, and FIG. 2D, adhered portions 2c of the medicine package 2 that is stored close to the bottom of the container 10 are illustrated.

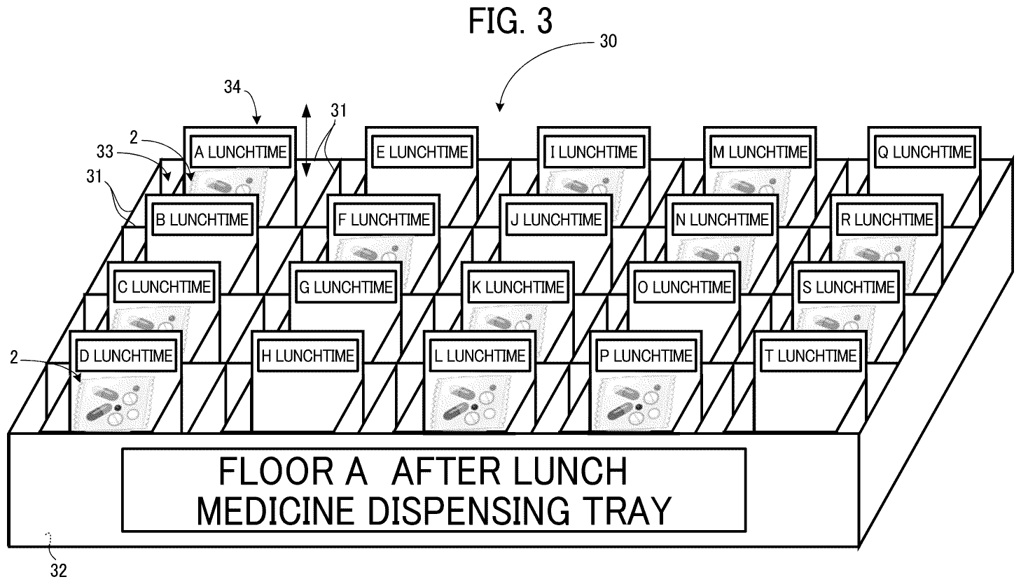

FIG. 3 is an external perspective view of the medicine dispensing tray 30 provided with subdivision boxes 34.

As illustrated in FIG. 3, each one of the medicine dispensing trays 30 has rooms 33 and partition walls 31 which are examples of multiple partitions for arranging prescribed packs, and each of the rooms 33 is partitioned by four upright partition walls 31. Each one of the medicine dispensing trays 30 has twenty rooms 33 that can be expressed as the components of a matrix including five columns in the X-axis direction or the line feed direction such as A, B, C, D, and E and four rows in the Y-axis direction or the character feed direction such as 1, 2, 3, and 4. As a result, each one of the twenty rooms 33 of the medicine dispensing trays 30 can be uniquely positioned based on the components and addresses of the matrix of five columns and four rows. Furthermore, each one of the multiple medicine dispensing trays 30 has a bottom wall 32 on which the multiple medicine packages 2 are placed. As described above, each one of the medicine dispensing trays 30 are arranged such that a specific one of the multiple packs arranged in a specific one of the rooms 33 will be placed in a specific one of the rooms 33 with reliability by the multiple partition walls 31, which are four partition walls in the present embodiment, and the bottom wall 32 in common, without being mixed up with packs in different one of the rooms 33 or dropping off from the bottom wall 32.

The medicine dispensing tray 30 includes a total of twenty rooms 33 divided by partition walls 31. In each one of the rooms 33 of the multiple medicine dispensing trays 30, a setting position or inserting position is determined for each patient who takes medicines depending on a type of medicines in the pack to be taken. In other words, the multiple rooms 33 in one of the multiple medicine dispensing trays 30 may be allocated to patients who take medicines at the same time. In a case where a specific patient who takes medicines does not take a medicine at a specific timing, arrangement can be made such that a pack is not given to such a specific patient at the specific timing. In the medicine dispensing tray 30 as illustrated in FIG. 3, “FLOOR A AFTER LUNCH MEDICINE DISPENSING TRAY” displayed on the front outer wall indicates that the tray is the medicine dispensing tray 30 in which the multiple packs to be taken after lunch by patients who take medicines and reside in the same floor A of, for example, a day-care center or nursing home are arranged.

According to the medicine dispensing tray 30 illustrated in FIG. 3, the rooms 33 are determined based on the patients who take medicines, and the rooms 33 or address from which the staff or the like of, for example, a day-care center or nursing home in which medication is supported using the medicine dispensing tray 30 take medicine every time become the same. Such a configuration allows prevention of a medication error. In other words, since the sections are not changed from day to day, it is possible to reduce the work of staff members and the like in a nursing home, day-care center and the like.

However, no limitation is intended by the medicine dispensing trays 30 described above. Each one of the multiple rooms 33 of one of the medicine dispensing trays 30 may be allocated for each time of medication of each patient who takes medicines. More specifically, in such an alternative embodiment of the present disclosure, the multiple rooms 33 may be allocated to each of the patients who take medicines in view of the time of medication of each one of the multiple medicine packages 2 to be taken in the morning, in the daytime, in the evening, or before going to bed. In the multiple medicine dispensing trays 30 according to such an alternative embodiment of the present disclosure, the multiple medicine dispensing trays 30 may be managed on a room by room basis or a floor by floor basis in day-care center or nursing home where patients who take medicines reside, and the multiple medicine packages 2 for that day or a couple of days may be dispersed in advance to the multiple medicine dispensing trays 30.

According to the above alternative embodiment, allocating the rooms 33 based on each time of medication such as a time in the morning, a time in the daytime, a time in the evening, and a time before going to bed can prevent the time of medication from being mistaken by patients who take medicines. The configuration or structure of the multiple medicine dispensing trays 30 is not limited to the embodiments of the present disclosure described above, and various kinds of combination are theoretically possible between patients who take medicines and the timing at which the medicines are to be taken. However, such combinations may go beyond the scope of the present disclosure, the description of such combinations is omitted.

FIG. 3 illustrates one of the multiple medicine dispensing trays 30 where a subdivision box 34 that is an example of a box attachable to and detachable from each one of the multiple rooms 33 is used. For example, the multiple subdivision boxes 34 hold the multiple medicine packages 2 filled with the medicines 3 to be taken by twenty residents A to T after lunch in day-care center or nursing home. In other words, one of the multiple medicine dispensing trays 30 illustrated in FIG. 3 is used to arrange prescribed packs in a predetermined or specific one of the multiple rooms 33 partitioned by dividers through the multiple subdivision boxes 34. The operation of placing the multiple medicine packages 2 in one of the multiple medicine dispensing trays 30 is briefly described later with a case in which the multiple subdivision boxes 34 are not used.

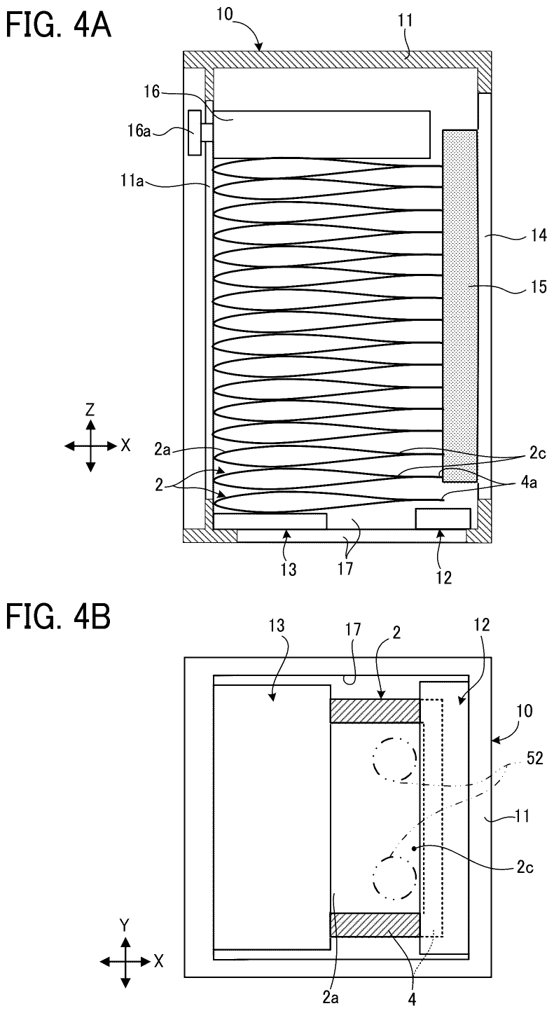

FIG. 4A is a vertical sectional view of the container 10.

FIG. 4B is a bottom view of the container 10 of FIG. 4A.

In FIG. 4A, the medicine packages 2 are schematically illustrated, and support portions such as a right support portion 12 and a left support portion 13 are schematically illustrated.

The container 10 includes a casing 11, a lid 14, a pack pickup slot 17, a movable board 16, a pack posture keeper 15, and a right support portion 12 and a left support portion 13 each of which serves as a support portion. The casing 11 has a function to contain or accommodate the multiple medicine packages 2. For example, the casing 11 is integrally or separately formed using resin. The lid 14 enables the multiple medicine packages 2 to be loaded or unloaded. The pack pickup slot 17 is formed in a lower portion or a bottom portion of the casing 11, and is used to pick up the medicine package 2 in one of the multiple containers 10. Moreover, the pack pickup slot 17 allows the medicine package 2, which is picked up from one of the multiple containers 10 by the pickup unit 50A (see, for example, FIG. 1A and FIG. 1B), to pass therethrough.

The movable board 16 prevents the medicine package 2 from falling out, and moves the lowermost one of the medicine packages 2 to a position close to the pack pickup slot 17 after the first one of the maximum number of medicine packages 2 that can be stored in the casing 11 is picked up. The pack posture keeper 15 keeps the posture of the medicine package 2. The right support portion 12 and the left support portion 13 also support or hold the medicine package 2 in the casing 11.

In the first comparative example, the to-be-picked-up portion of one of the multiple medicine packages 2 to be picked up from one of the multiple containers 10 by the pickup unit 50A is at a lower portion or bottom portion of the corresponding one of the multiple containers 10. In other words, the to-be-picked-up portion includes the pack pickup slot 17, and the right support portion 12 and the left support portion 13 that serve as a pair of support portions or supporting member and support, at points, one of the multiple medicine packages 2 to be picked up from one of the multiple containers 10.

When one of the multiple medicine packages 2 is picked up from one of the multiple containers 10 by the pickup unit 50A, the right support portion 12 and the left support portion 13 allow one of the multiple medicine packages 2 to pass through. On the other hand, when any one of the multiple medicine packages 2 is not to be picked up from one of the multiple containers 10, the right support portion 12 and the left support portion 13 restrict the passage of one of the multiple medicine packages 2 to store and hold the multiple medicine packages 2 in the casing 11.

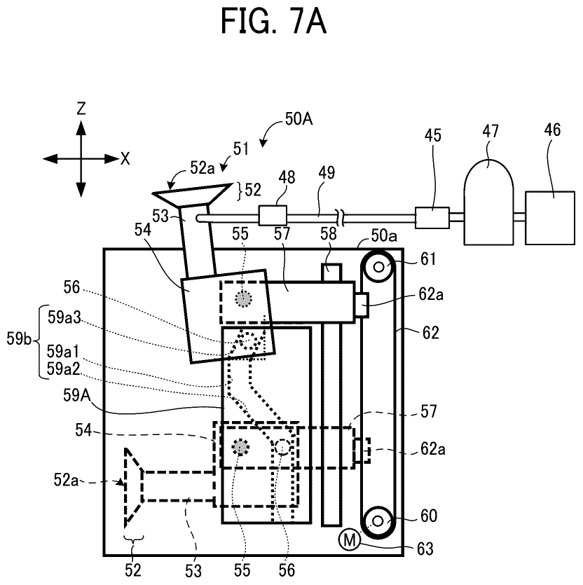

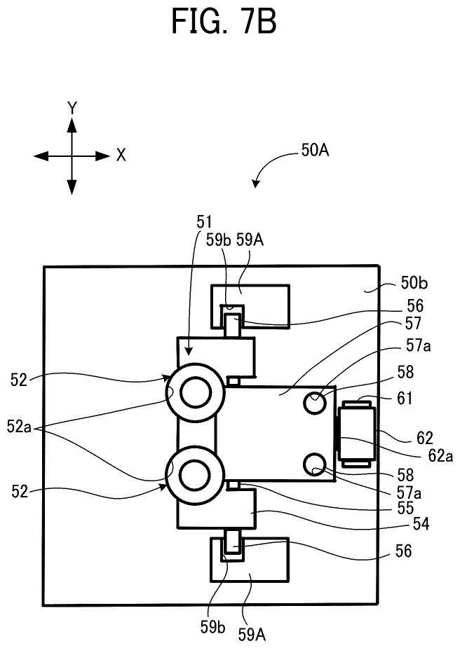

As described above, the right support portion 12 and the left support portion 13 support or hold the medicine packages 2 in the container 10, and each one of the right support portion 12 and the left support portion 13 is fixed and immovable such that one of the multiple medicine packages 2 can be picked up in a stable manner from one of the multiple containers 10 by the pickup unit 50A. The right support portion 12 and the left support portion 13 are a pair of fixation members that are fixed or attached to the pair of bottom-wall inner surfaces of the right bottom-wall edge and left bottom-wall edge of the pack pickup slot 17, respectively. The pack pickup slot 17 has a function to allow the suction pad 52 of the pickup unit 50A as will be described later in detail with reference to, for example, FIG. 7A and FIG. 7B to pass therethrough in order to pick up one of the multiple medicine packages 2, and has a function to let the medicine package 2 that is picked up and the suction pad 52 to pass through. In other words, the pack pickup slot 17 and the above right bottom-wall edge and left bottom-wall edge that are arranged so as to surround the pack pickup slot 17 together serve as a pack passing-through portion according to the present embodiment.

In one of the multiple containers 10 illustrated in FIG. 4B, a pair of positions at which the pair of suction pads 52 (as will be described later in detail with reference to FIG. 7A and FIG. 7B) adsorb or suck up one of the multiple medicine packages 2 stored in one of the multiple containers 10 are indicated by a pair of ring-shaped dot-dot-dash lines as illustrated in FIG. 4B. Such a pair of positions may be referred to as a pair of suction-pad positions in the following description. The right support portion 12 and the left support portion 13 support or hold the medicine packages 2 in the container 10 such that the medicine packages 2 in one of the containers 10 do not fall off from the pack pickup slot 17. As will be described later in detail in regard to the operation of the pickup unit 50A, when the medicine package 2 at the bottom of the container 10 is sucked and picked up by the pair of suction pads 52, one of the multiple medicine packages 2 is sucked by the suction pad 52 at two suction-pad positions in the Y-axis direction near both ends of the right support portion 12. When the lowermost one of the medicine packages 2 is picked up from one of the multiple containers 10 by the suction pads 52, the two suction pads 52 pass near both ends of the right support portion 12 in the Y-axis direction to suck and hold one of the multiple medicine packages 2.

As illustrated in FIG. 4B, two points at which the suction pad 52 contacts are arranged near both ends of the right support portion 12 in the Y-axis direction. Due to such a configuration, the possibility of an error in which the suction by the pair of suction pads 52 is disabled can be avoided and prevented, and the picking up operation can successfully be done. As two side portions of the medicine package 2 in the Y-axis direction are sucked and adhered to the pair of suction pads 52, the bag 2a, which is made of film, of the medicine package 2 is stretched by the suction of the pair of suction pads 52, and can withstand deformation. Accordingly, both reliable support or holding of the multiple medicine packages 2 in one of the multiple containers 10 and smooth removal of one of the multiple medicine packages 2 can be achieved.

The pack posture keeper 15 is formed of sponge rubber having appropriate elasticity or resistance. The movable board 16 is made of, for example, resin or metal. The pack posture keeper 15 and the movable board 16 according to the present embodiment hold the posture of the multiple medicine packages 2 under normal operating conditions in the casing 11. As explicitly illustrated in FIG. 4A, the posture of the multiple medicine packages 2 is held orderly in the Z-axis direction in a substantially horizontal state. In order to achieve the above-described function, the movable board 16 is arranged to move at least one of the multiple medicine packages 2 left in the casing 11 toward the pack pickup slot 17 as moving downward in the casing 11 in the Z-axis direction by its own weight. As illustrated in FIG. 4A, a long groove 11a that extends in the Z-axis direction with predetermined width in the X-axis direction is formed in the side wall of the casing 11. A shaft 16a with a flange is arranged at one end of the movable board 16 so as to protrude from the long groove 11a. As the shaft 16a of the movable board 16 is guided in the Z-axis direction parallel to the long groove 11a, the posture of the multiple medicine packages 2 can be held in the Z-axis direction. In FIG. 4A and FIG. 4B, the multiple medicine packages 2 in the multiple containers 10 are stacked on top of each other in layers in a substantially horizontal state. However, in actuality, left portions of the medicine packages 2 in FIG. 4A and FIG. 4B filled with the medicines 3 are expanding.

A set of the multiple medicine packages 2 are orderly stored in the casing 11 toward the upper side from the pack pickup slot 17 on the right support portion 12 and the left support portion 13. The timing at which the multiple medicine packages 2 are supplied into one of the multiple containers 10 may be, for example, the timing at which a patient who takes medicines or occupant is examined in a day-care center or nursing home, which is typically once a two weeks, or the timing at which the multiple medicine packages 2 in one of the multiple containers 10 run out. When some medicine packages 2 are left in one of the multiple containers 10 at the time of replenishment, such replenishment is continued from the back of the remaining medicine packages 2. Under normal operating conditions, the above-described setting of the multiple medicine packages 2 into one of the multiple containers 10 and the replenishment of the multiple medicine packages 2 are done by a staff or the like in a day-care center or nursing home. However, no limitation is indicated thereby. In particular, in configurations where the containers 10 are used as cartridges and setting or replenishment of the medicine packages 2 are done automatically, the setting or replenishment of the medicine packages 2 may be done differently.

The lid 14 is used by a staff or the like who works at a day-care center or nursing home to enable loading or unloading of the multiple medicine packages 2 stored in one of the multiple containers 10, and as illustrated in FIG. 4A, is formed with wide length in the Z-axis direction of the casing 11 and has a predetermined opening width.

As illustrated in FIG. 4A, the types of the multiple medicine packages 2 in one of the multiple containers 10 are sorted or divided based on the timings at which medicines are taken. For example, one cartridge contains medicines to be taken in fourteen days in the morning by Mr. or Ms. A. In view of the above circumstances, if Mr. or Ms. A takes the medicines not only in the morning but also in the daytime or in the evening, or before going to bed, four containers 10 are required in total. However, no limitation is intended thereby. For example, a single container 10 may be prepared for each patient who takes medicines. In such cases, a pack to be used in the morning on day one, a pack to be used at lunchtime on day one, a pack to be used in the evening on day one, a pack to be used before going to bed on day one, a pack to be used in the morning on day two, a pack to be used at lunchtime on day two, and a pack to be used in the evening on day two may be stored in the order listed upward from the pack pickup slot 17 parallel to the direction in which packs are taken out from the multiple containers 10.

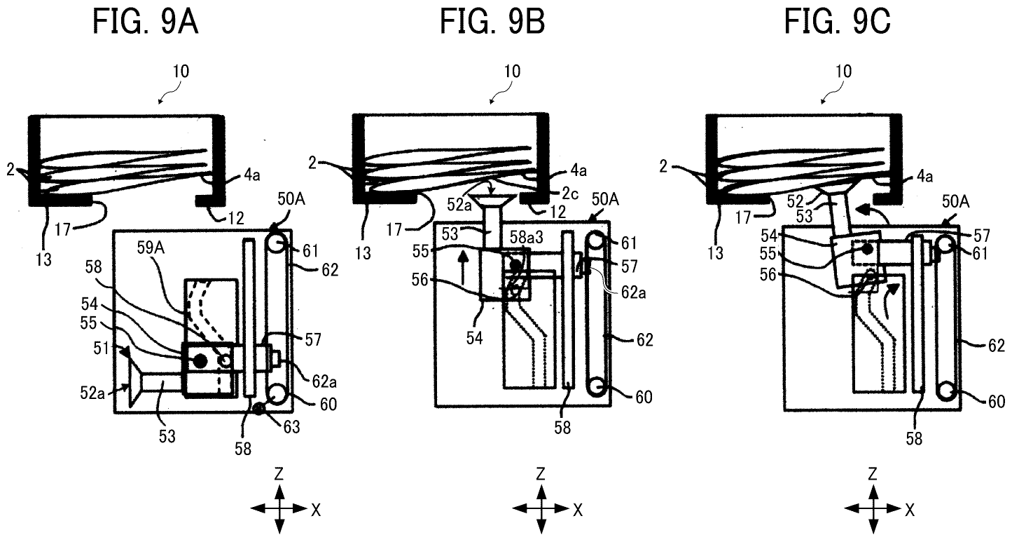

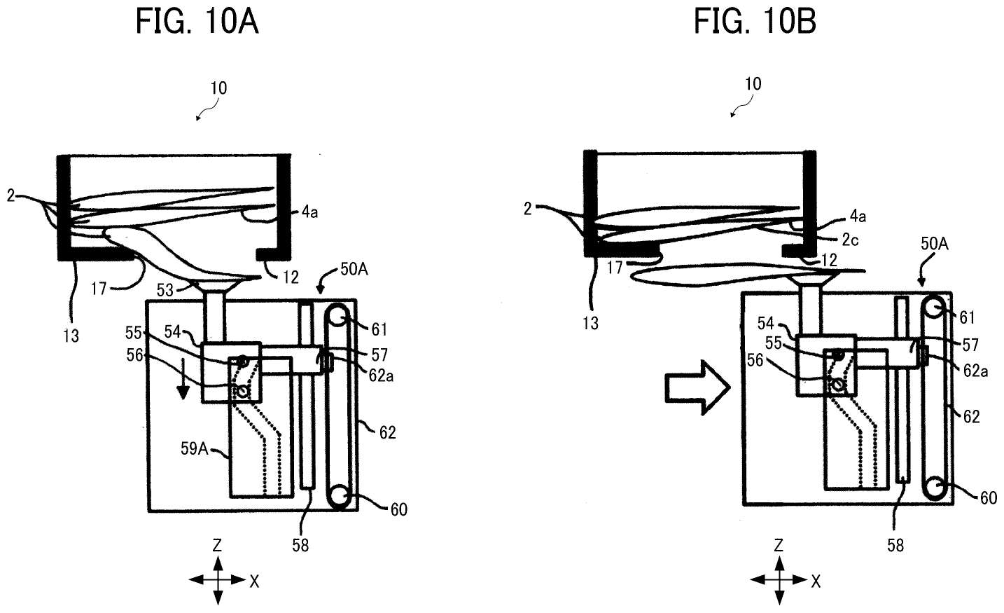

The medicine package 2 that is stored in the container 10 is supported by a right support portion 12 and a left support portion 13 so as not to drop. The right support portion 12 supports a right end where the medicine package 2 is sucked up, and the left support portion 13 supports a left end on the other side. The right support portion 12 and the left support portion 13 are different in the length of the portion that support the multiple medicine packages 2, and the length of portion of the right support portion 12 that support the multiple medicine packages 2 is shorter than that of the left support portion 13. When the lowermost one of the multiple medicine packages 2 stored in one of the multiple containers 10 is pulled out in the Z-axis direction by the suction pad 52, the medicine pack such as the medicine packages 2 is bent or freely deformed due to its elasticity. Accordingly, the medicine pack can easily be pulled out (as will be described later in detail with reference to, for example, FIG. 9A to FIG. 9C, FIG. 10A, and FIG. 10B).

As the pair of support portions including the right support portion 12 and the left support portion 13 are of fixed type, the front end of the next one of the multiple medicine packages 2 to be taken out can be reliably held and does not jump out or fall off together with one of the multiple medicine packages 2 that is being taken out. As the pair of support portions including the right support portion 12 and the left support portion 13 do not swing or rotate, the medicine package 2 are held with high stability with no deformation or the like due to unintentional nipping or pressing in the returning operation.

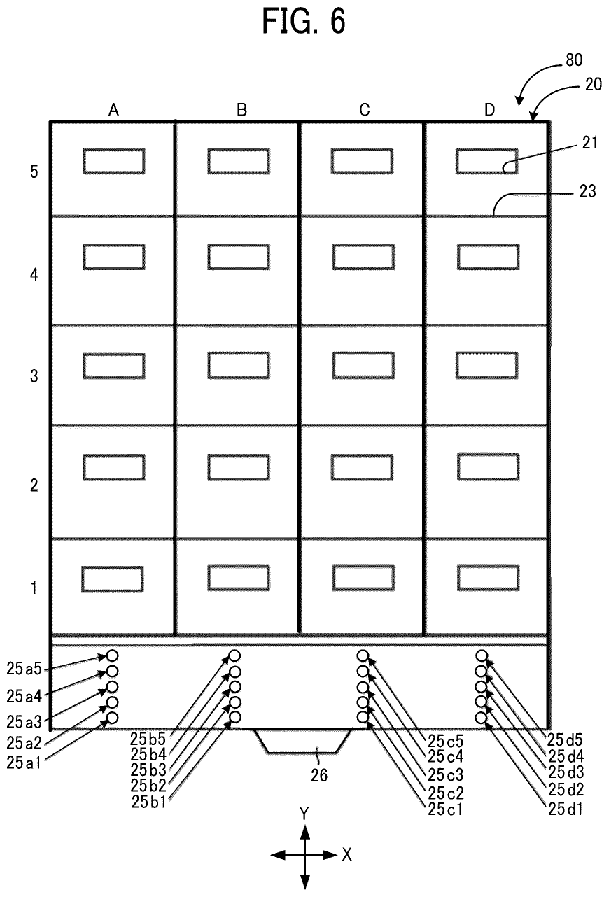

The attaching and detaching mechanisms and operations of the multiple containers 10 that are arranged in the drawer 80 are described below with reference to FIG. 5 and FIG. 6. FIG. 5 is a schematic plan sectional view of the attaching and detaching mechanisms for the container 10, which are arranged on the drawer 80. FIG. 6 is a schematic plan view of the containers 10 and illustrates the mechanisms for recognizing each one of the containers 10, which are arranged on the drawer 80. As illustrated in FIG. 5, the drawer 80 is configured to allow the multiple containers 10 to be attachable and detachable through the container tray 20. As known in the art, each one of the multiple containers 10 that is configured to be detachable as described above may be referred to as a cartridge. The drawer 80 is integrally formed with the container tray 20 to hold the container tray 20. The casing 22 of the container tray 20 in the drawer 80 is provided with a pair of slide rails 81 on the right and left outer side walls, and the pair of slide rails 81 are slidable with the rails provided for the housing 199 (see FIG. 1A and FIG. 1B). Due to such a configuration, the multiple container trays 20 in the drawer 80 can be attached or detached by being pulled out from the housing 199 (see FIG. 1A and FIG. 1B) through the engagement between the pair of slide rails 81 and the rails of the housing 199.

As illustrated in FIG. 5, one of the containers 10 is attached to and detached from the container tray 20 in the drawer 80 through the engagement and disengagement between a pair of concave portions 11c on the external wall of the casing 11 of the container 10 and a pair of convex portions 23a that are formed on the inner wall of the casing 22 of the drawer 80 and protrude inwardly and the engagement and disengagement between the inner wall of the casing 22 and four hemispherical protrusions 11d on the external wall of the casing 11. With the above-described attaching and detaching mechanism of the drawer 80, the multiple containers 10 can be attached or detached easily and with good operability. In the above embodiments of the present disclosure, attachment and detachment are enabled by the coupling or engagement of concave and convex portions. However, no limitation is intended thereby, and an elastic member may be arranged in the gap between the inner wall of the casing 22 and the external wall of the casing 11 to enable attachment and detachment. Alternatively, a configuration or structure using magnetic force or a snap-fit assembly method may enable attachment and detachment. As illustrated in FIG. 5 and FIG. 6, a rectangular through opening 21 that communicates with the pack pickup slot 17 of one of the multiple containers 10 as illustrated in FIG. 4A and FIG. 4B when each one of the multiple containers 10 is attached to the each one of the multiple containers 23 of the container tray 20 is formed on the bottom wall of the container tray 20 of the drawer 80.

As illustrated in FIG. 6, the container tray 20 of the drawer 80 has containers 23 in which twenty containers 10 are stored. The containers 23 have four columns of A to D in the horizontal direction, and has five rows of 1 to 5 in the vertical direction. The drawer 80 has a grip 26 that is held by hand to insert or withdraw the drawer 80, and information display devices such as light-emitting diodes (LEDs) 25al to 25d5 are arranged near the grip. Due to such a configuration, the arrangement of the multiple containers 10 can easily be figured out. More specifically, due to such a configuration, at what position one of the multiple containers 10 in focus is placed in the container tray 20 of the drawer 80 can easily be figured out at a glance. In FIG. 6, the light-emitting diode (LED) 25al is used to detect the presence or absence of one of the multiple containers 10 attached to or detached from a storage unit A1 of the container tray 20. The storage unit A1 indicates a position or partition that is uniquely determined in the vertical columns and horizontal rows. In a similar manner to the above, the LED 25a2 corresponds to a portion of the container A2 of the container tray 20, and the LED 25a3 corresponds to a portion of the storage unit A3 of the container tray 20. Moreover, the LED 25a4 corresponds to a portion of the storage unit A4 of the container tray 20, and the LED 25a5 corresponds to a portion of the storage unit A5 of the container tray 20. In a similar manner to the above, as illustrated in FIG. 6, each one of three columns of B to D and five rows of 1 to 5 of the containers 10 is provided with an LED that indicates whether one of the multiple containers 10, which is attached to and detached from one of the multiple containers 10, is present. When information display devices such as the multiple LEDs 25al to 25d5 are used, for example, a staff who is an operator to attach one of the multiple containers 10 to one of the multiple containers 23 may mistake the lighting portion of the LEDs 25al to 25d5. In such cases, the container 10 may erroneously attached to a wrong container other than a desired one of the multiple containers 23. In order to handle such a situation, for example, whether the container 10 is present may electrically or automatically be recognized by arranging detection units such as sensors or switches at the multiple containers 23 in place of information display devices such as the multiple LEDs 25al to 25d5.

The container may be provided with for example, a number, a bar code, a quick response (QR) code (registered trademark), or a non-contact integrated circuit (IC) tag such that each one of the containers will be identifiable. It is desired that the system be programmed to remember what container stores whose medicines. Subsequently, the drawer 80 to which the multiple containers are attached is set in the housing 199 of the medication support device 200, and each one of the multiple containers is identified by the medication support device 200. Due to such a configuration, a desired pack can be picked up by the medication support device 200 without causing any errors.

FIG. 7A is a front view of the pickup unit 50A, illustrating a configuration or structure of the pickup unit 50A.

FIG. 7B is a plan view of the pickup unit 50A of FIG. 7A.

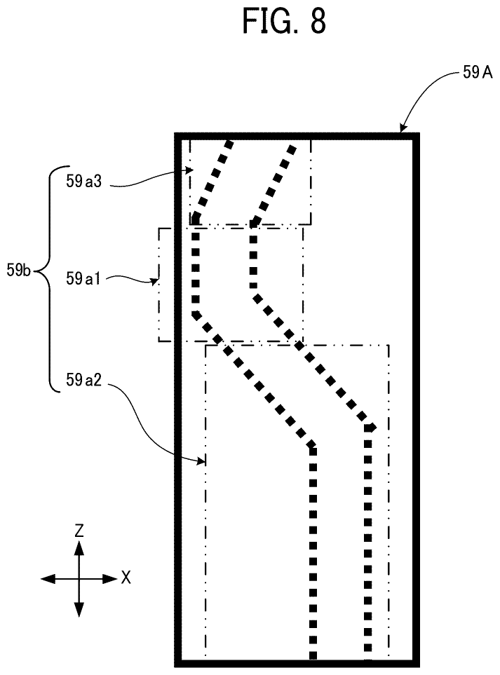

FIG. 8 is a magnified view of a guide unit 59A and a guide groove 59b of the pickup unit 50A of FIG. 7A.

FIG. 9A to FIG. 11B are front views of the pickup unit 50A according to the first comparative example, illustrating the progression of the operation of the pickup unit 50A.

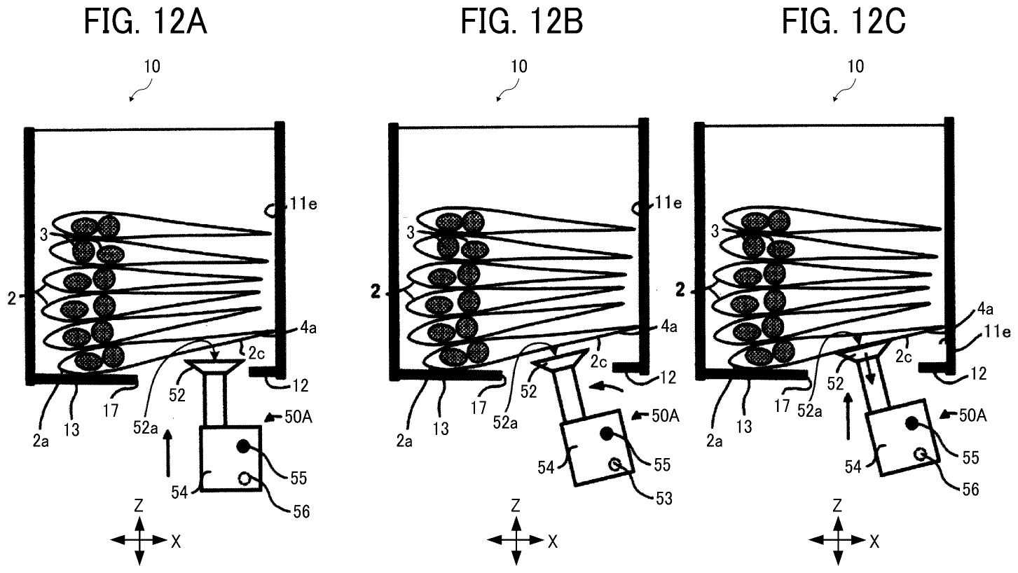

FIG. 12A to FIG. 12C are supplemental diagrams illustrating how the pickup unit 50A according to the first comparative example can suck and hold the medicine package 2 at the bottom of the container 10 as desired.

How, for example, the negative-pressure generator 45 is coupled to the pickup unit 50A is illustrated in FIG. 7A. As illustrated in FIG. 7A, the pickup unit 50A includes a suction device 51 that picks up and holds one of the multiple medicine packages 2 from one of the multiple containers 10. The suction device 51 has a function to such up and separate the medicine package 2. When the medicine package 2 is to be sucked up, the suction device 51 has a function to suck up the medicine package 2 using the air under negative pressure generated by the negative-pressure generator 45 that serves as a switching unit between positive pressure and negative pressure. The suction device 51 according to the present embodiment has a function to separate the medicine package 2 using the pressurized air generated by the negative-pressure generator 45 when the medicine package 2 is to be separated.

As illustrated in FIG. 7A, the suction device 51 as described above sucks up one of the multiple medicine packages 2 as the negative-pressure generator 45 transforms the positive pressure generated by an air compressor 46 that serves as an air compressing means into negative pressure through an air tank 47. The air compressor 46 is installed outside the conveyor 90, and is coupled to the suction device 51 through the air tank 47 and the negative-pressure generator 45 by a communicating member such as an air tube 49. In the air tube 49 between the negative-pressure generator 45 and the suction device 51, a pressure sensor 48 that measures the negative pressure is arranged to determine that the suction device 51 has sucked up one of the multiple medicine packages 2 when the negative pressure measured by a pressure sensor that measures the negative pressure becomes equal to or less than a predetermined value.

The air tube 49 is arranged together with, for example, a pair cable and a wire harness so as not to be stretched even when the pickup unit 50A moves inside the medication support device 200. In other words, as illustrated in FIG. 1A and FIG. 1B, the air tube 49 according to the present comparative example has a one-turn path for each one of the X-axis, the Y-axis, and the Z-axis. Firstly, the air tube 49 is extended from the negative-pressure generator 45 in the Z-axis direction, and makes one turn. Secondly, the air tube 49 is extended in the X-axis direction, and makes one turn. Finally, the air tube 49 is extended in the Y-axis direction and makes one turn, and is coupled to the suction device 51.

The suction device 51 has a suction pad 52 that sucks one of the multiple medicine packages 2, and a suction duct 53 coupled to the pair of suction pads 52. The negative-pressure generator 45 is also called a vacuum ejector valve and communicates with the suction duct 53 through the air tube 49. The suction pad 52 is an example of an air suction unit or a suction member that sucks up and picks up one of the multiple medicine packages 2 in one of the multiple containers 10. As described above, the upper ends of the pair of suction pads 52 as illustrated in FIG. 7A is arranged to absorb one of the multiple medicine packages 2. The bottom ends of the pair of suction pads 52 as illustrated in FIG. 7A is attached and fixed to the upper end of the suction duct 53 as illustrated in FIG. 7A. The bottom end of the suction duct 53 as illustrated in FIG. 7A is attached and fixed to the suction-pad supporting member 54. A pair of suction pads 52 and suction ducts 53 are arranged in the Y-axis direction.

The pickup unit 50A is provided with a posture changing unit used to change the posture of one of the medicine packages 2 picked up from one of the containers 10 to a substantially vertical posture. The posture changing unit in the pickup unit 50A includes, for example, a suction-pad supporting member 54 coupled to a suction device base 57 through a rotary shaft 55, the guide unit 59A provided with guide grooves 59b formed with first to third guide grooves 59a1, 59a2, and 59a3 each of which has a specific shape, a guide axis 56 that is consistently fitted into one of the above three guide grooves 59a1, 59a2, and 59a3 formed on the guide unit 59A to guide the suction-pad supporting member 54, and a suction-device lifting and lowering unit.

The suction-pad supporting member 54 is coupled to the suction device base 57 through the rotary shaft 55. The suction-pad supporting member 54 may be may rotatably or pivotably be arranged around the rotary shaft 55 fixed to the suction-pad supporting member 54 within a range of a predetermined angle. Alternatively, the suction-pad supporting member 54 may be may rotatably or pivotably be arranged around the rotary shaft 55 fixed to the suction device base 57. In other words, in FIG. 7A and FIG. 7B, the distance between the center of the rotary shaft 55 and the center of a guide rod 58 in the X-axis direction is kept constant at all times when the suction device base 57 moves along the guide rod 58 in the up and down directions parallel to the Z-axis direction. The guide rod 58 will be described later in detail.

The suction-device lifting and lowering unit includes a pair of guide rods 58 that are arranged in the Y-axis direction to guide the suction device base 57 in the Z-axis direction, an endless belt 62 looped around a driving pulley 60 and a driven pulley 61, and a drive motor 63 coupled to a driving pulley 60 through a driving power conveyor such a gear or a belt. The drive motor 63 is an example of a driver circuit or driving source of the suction-device lifting and lowering unit.

The suction device base 57 is coupled and fixed to the endless belt 62 at a belt grip 62a fixed to the right end of the suction device base 57. The pair of guide rods 58 that are arranged in the Y-axis direction extend in the Z-axis direction, and the bottom ends of those guide rods 58 are fixed to a base frame 50b of the picking-up frame 50a provided for the pickup unit 50A. A pair of guiding holes 57a into which the pair of guide rods 58 are inserted are formed around a right end of the suction device base 57. The pulley axis of each one of the driving pulley 60 and the driven pulley 61 is rotatably supported by an immovable member on the picking-up frame 50a. The drive motor 63 is fixed to an immovable member on the picking-up frame 50a of the pickup unit 50A.

When the suction device base 57 is lifted or lowered by the operation of the drive motor 63, the suction device base 57 is moved along the pair of guide rods 58 in the Z-axis direction. Accordingly, the posture of the suction device base 57 on the XY plane can be kept constant in a substantially horizontal state. The suction unit lifting and lowering unit is not limited to the above-described up-and-down reciprocating mechanism driven by a belt. Alternatively, for example, the suction unit lifting and lowering unit may have a reciprocating linear motion mechanism using a rack and pinion.

As the guide axis 56 is guided to the first guide groove 59a1, the second guide groove 59a2, and the third guide groove 59a3, the guide grooves 59b each of which has a specific shape and is formed on the guide unit 59A holds the posture of the pair of suction pads 52 in a predetermined direction through the suction-pad supporting member 54 as illustrated in FIG. 7A. The guide grooves 59b includes the first guide groove 59a1 in which the suction device base 57 can move with approximately horizontal posture when the suction pad 52 moves from its standby position to a pack-sucking position, the second guide groove 59a2 that gradually moves to the right side as it goes downward to rotate the posture of the suction-pad supporting member 54 and the pair of suction pads 52 by approximately 90 degrees, and the third guide groove 59a3 that communicates with and is connected to the top end of the first guide groove 59al and gradually moves to the right side as it goes upward to rotate the posture of the suction-pad supporting member 54 and the pair of suction pads 52 to the left. The first guide groove 59al and the second guide groove 59a2 communicate with each other and are coupled to each other.

The first guide groove 59al and the second guide groove 59a2 that are formed on the guide unit 59A to change the posture or attitude of the medicine package 2 picked up from the container 10 from an approximately horizontal state in which the direction of the thickness of the medicine package 2 is substantially vertical to a substantially vertical posture is equivalent to posture changing unit.

The guide axis 56 and the third guide groove 59a3 of the guide grooves 59b each of which has a specific shape and is formed on the guide unit 59A make up an angle changing mechanism that changes the angle of the pair of suction pads 52 to a desired direction with respect to the medicine package 2 with the pair of suction pads 52 contacting the medicine package 2 at the bottom of the container 10. The angle changing mechanism controls the pair of suction pads 52 when the pair of suction pads 52 suck one of the medicine packages 2, and makes the pair of suction pads 52 suck up one of the multiple medicine packages 2 in accordance with the inclination of the medicine package 2 at the bottom of the container 10.

As will be described later in detail, when the pair of suction pads 52 rise toward the bottom of the container 10, firstly, the pair of suction pads 52 and their suck-and-hold planes 52a enter the space under the container 10 at an approximately horizontal angle, and then the angle of the pair of suction pads 52 with reference to one of the multiple medicine packages 2 at the bottom is changed depending on the extent to which the pair of suction pads 52 have entered the container 10.

The above angle changing mechanism is provided with a mechanism including a link and slide guide. More specifically, the above angle changing mechanism includes a kind of link, which is a link member of the suction-pad supporting member 54 that guides the suction-pad supporting member 54 and connects the rotary shaft 55 and the guide axis 56 fitted into the guide groove 59b, and a slide guide, which is the guide grooves 59b including the third guide groove 59a3 on the guide unit 59A. The suction-pad supporting member 54 is a driven section coupled to the suction device base 57 that is a drive section and moves upward and downward through the rotary shaft 55.

As illustrated in FIG. 1A, FIG. 1B, and FIG. 7A, the pickup unit 50A is provided with the suction device 51 that uses the air as a pickup device, and is provided with an air tank 47, an air compressor 46, and a negative-pressure generator 45 so as to perform suctioning using the air. Those elements are coupled to each other by, for example, the air tube 49 or a joint used for piping.

In the medication support device 200, vacuum breakdown can be performed. As the negative-pressure generator 45 generates negative pressure by placing the air under negative pressure using the air compressed by the air compressor 46, the pack that contacts the pair of suction pads 52 of the suction device 51 with adhesion can be sucked and kept. On the contrary, the negative-pressure generator 45 may generate pressure to send out the air to the pair of suction pads 52 of the suction device 51. By so doing, the air discharges at the suck-and-hold planes 52a of the pair of suction pads 52, and the kept pack can be released.

FIG. 9A to FIG. 11B are front views of the pickup unit 50A according to the first comparative example, illustrating the progression of the operation of the pickup unit 50A.

A pick-out operation in which the medicine packages 2 are taken out from the container 10 is described with reference to FIG. 9A to FIG. 10A.

In the progression of the operation of the pickup unit 50A, it is assumed that, due to the operation of the conveyor 90 illustrated in FIG. 1A and FIG. 1B, the pickup unit 50A is arranged below the container 10 provided for one of the drawers 80 arranged at the central portion of the housing 199 illustrated in FIG. 1A and FIG. 1B. After the pair of suction pads 52 of the pickup unit 50A sucks and pulls out the lowermost pack in the container 10, as the conveyor 90 operates, the pickup unit 50A moves above the medicine dispensing tray 30, which is placed uppermost in FIG. 1A and FIG. 1B. Then, the pickup unit 50A drops and insert the pack into the subdivision box 34 arranged at a specific partition of the medicine dispensing tray 30 to dispense medicine.

Once medicine dispensing operations start as illustrated in FIG. 9A, firstly, the pickup unit 50A moves to a position under the container 10 in order to pick up a desired pack by the operation of the conveyor 90 illustrated in FIG. 1A and FIG. 1B, and then stops moving and goes on standby. At that moment in time, the drive motor 63 stops its operation, and the suck-and-hold planes 52a of the pair of suction pads 52 takes an approximately vertical or upright posture. Subsequently, the drive motor 63 starts operating, and as illustrated in FIG. 9B, the suction device base 57 and the pair of suction pads 52 move upward in a straight line. In so doing, the pair of suction pads 52 enter from the pack pickup slot 17 between the right support portion 12 and the left support portion 13 after the suck-and-hold planes 52a of the pair of suction pads 52 changes its posture from an approximately vertical or upright posture to an approximately horizontal posture.

Subsequently, when the pair of suction pads 52 move further upward, the guide axis 56 moves to the third guide groove 59a3 of the guide unit 59A. Accordingly, the pair of suction pads 52 rise, and the suction-pad supporting member 54 rotates towards the left as indicated by an arrow in FIG. 9C. In parallel with that, the pair of suction pads 52 enter lower space of the container 10 while rotating toward the left. In so doing, the negative-pressure generator 45 (see FIG. 7A) has been driven in advance so as to enable sucking operation. When the medicine package 2 is approximately horizontally stored in the container 10, that medicine package 2 is at the bottom of the container 10. In such cases, that medicine package 2 is sucked immediately after the pair of suction pads 52 enter the container 10 approximately horizontally.

As described above, the medicine package 2 has a greater thickness at the bag 2a formed of a film (see, for example, FIG. 2A to FIG. 2D). For this reason, even if the medicine packages 2 are pressed down from above by the movable board 16 inside the container 10 illustrated in FIG. 4A and FIG. 4B, such pressing-down force is applied to thick portions of the packages. Due to such a configuration, although the bag 2a formed of a film is pressed down to the bottom face of the container 10, there are some cases in which the adhered portions 2c on the other side are caught by the sidewall of the casing 11 and are not pressed down to the bottom face of the container 10. Under these conditions, the adhered portions 2c of the medicine package 2 are positioned above the bottom face of the container 10. In other words, the adhered portions 2c are inclined upward when the medicine packages 2 are stored. Under these conditions, there are some cases in which the pair of suction pads 52 do not reach the medicine package 2 even when the pair of suction pads 52 enter the container 10, and there are some cases in which the medicine package 2 cannot be sucked up due to the gap with the pair of suction pads 52 even when the pair of suction pads 52 reach the medicine package 2.

When the medicine packages 2 are approximately horizontally stored in the container 10, that medicine package 2 is at the bottom of the container 10. In such cases, the medicine package 2 is sucked and adhered to the pair of suction pads 52 immediately after the pair of suction pads 52 horizontally enter the container 10. When the medicine packages 2 are stored in the container 10 with some inclinations, the pair of suction pads 52 further rise and tilt toward the left that is the direction in which the medicine packages 2 are inclined, and then the medicine package 2 at the bottom is sucked and adhered to the pair of suction pads 52.

As illustrated in FIG. 9B and FIG. 9C, when the medicine package 2 at the bottom is inclined toward the bottom left and the bag 2a of the medicine package 2 on the left contacts the left support portion 13 in the container 10, the pair of suction pads 52 tilt toward the bottom left in accordance with the direction in which the medicine package 2 at the bottom is inclined as the pair of suction pads 52 further rise. In such cases, the gap between the adhered portions 2c of the lowermost one of the medicine packages 2 and the suck-and-hold planes 52a of the pair of suction pads 52 is reduced to almost none, and the medicine package 2 is sucked and adhered to the pair of suction pads 52.

Subsequently, as illustrated in FIG. 10A, as the drive motor 63 is reversely operated, the pair of suction pads 52 move downward while sucking one of the medicine packages 2 by the pair of suction pads 52, and the front end of one of the medicine packages 2 is pulled out from the container 10. The front end of the medicine package indicates a side of the medicine package to be absorbed or sucked up by the pair of suction pads 52.

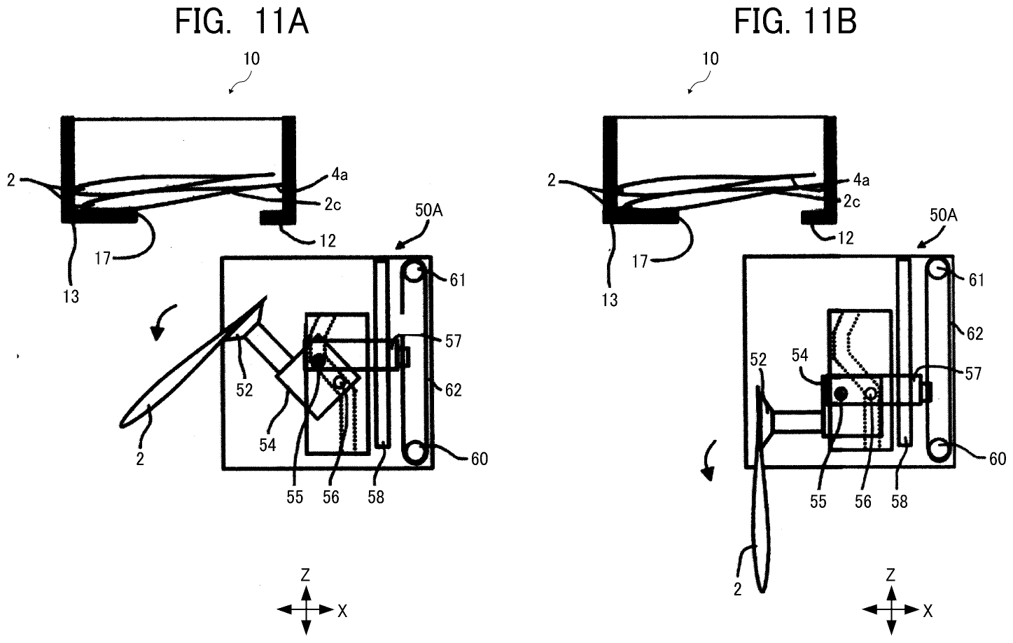

Subsequently, as illustrated in FIG. 10B, by the operation of the conveyor 90 (see FIG. 1A and FIG. 1B), the pickup unit 50A is moved in the X-axis direction, which is the lateral or horizontal direction, and the rear end of one of the multiple medicine packages 2 is drawn out or picked up from one of the multiple containers 10. Immediately after that, as illustrated in FIG. 11A and FIG. 11B, by the operation of the drive motor 63, one of the multiple medicine packages 2, which is approximately in a horizontal state and is sucked and held by the pair of suction pads 52, is rotated by substantially 90 degrees to change the posture to an approximately vertical or upright posture. In such rotational operation, the guide axis 56 that is arranged on the suction-pad supporting member 54 moves along the guide grooves 59b on the guide unit 59A. Accordingly, the posture of one of the multiple medicine packages 2 can be changed from an approximately horizontal posture to an approximately vertical posture. The above series of operation in the above configuration may be achieved by a series of operation performed by a single drive motor 63.

In the present embodiment, the expression “approximately horizontal” indicates that the posture of a particular element is within a specific range of tolerance for angle with respect to the horizontal or vertical, which is allowable in achieving the effects of the embodiments of the present disclosure, in addition to a state in which the position of a particular element is horizontal.

As described above, the pickup unit 50A takes out the front end of the medicine package 2 at the bottom to a position under the container 10 in the process of picking up out one of the multiple medicine packages 2 from one of the multiple containers 10. When the front end of the medicine package 2 at the bottom is taken out to a position under the container 10, the conveyor 90 moves the pickup unit 50A such that the rear end of the medicine package 2 on the other side will be taken out from the container 10. The direction in which the pickup unit 50A is moved by the conveyor 90 is made parallel to the X-axis direction, i.e., the lateral direction in which the rear end of the medicine package 2 is released from the left support portion 13 and is pulled out from the pack pickup slot 17.

FIG. 12A to FIG. 12C are supplemental diagrams illustrating how the pickup unit 50A according to the first comparative example as described as above with reference to FIG. 7A to FIG. 11B can suck and hold the medicine package 2 at the bottom of the container 10 as desired.

In the medicine packages 2 stacked on top of each other in the container 10, there are some cases in which the front end 4a of the pressure-bonded portion 4 in the adhered portions 2c is hooked on an interior wall 11e of the casing 11 of the container 10. In such cases, the bag 2a of the medicine package 2 contacts the inner bottom of the container 10 or an area around the top surface of the left support portion 13. When such a contacting portion between the bag 2a and the inner bottom of the container 10 serves as a fulcrum, the front end 4a of the pressure-bonded portion 4 is inclined obliquely upward and is not pressed down to the bottom face of the container 10. Under these conditions, the adhered portions 2c of the medicine package 2 are placed above the inner bottom of the container 10. In other words, the adhered portions 2c are inclined upward when the medicine packages 2 are stored (see, for example, FIG. 12A to FIG. 12C).

FIG. 12A illustrates a point in time at which the pair of suction pads 52 has entered the bottom portion of the container 10 in order to suck and hold the medicine package 2 stored at the bottom of the container 10. At that moment in time, suck-and-hold planes 52a of the pair of suction pads 52 are approximately horizontal, and a clearance is left between the medicine package 2 at the bottom and the suck-and-hold planes 52a of the pair of suction pads 52. When the pair of suction pads 52 further enter the container 10 and the suck-and-hold planes 52a of the pair of suction pads 52 change their states from FIG. 12A to FIG. 12B, as described above, the angle of the pair of suction pads 52 changes due to the unique shape of the guide grooves 59b of the guide unit 59A, and the angle of the pair of suction pads 52 changes depending on the extent to which the pair of suction pads 52 have entered the container 10. More specifically, the pair of suction pads 52 rotate in a counterclockwise direction and tilt toward the bottom left. As a result, the clearance between the medicine package 2 at the bottom and the suck-and-hold planes 52a of the pair of suction pads 52 is reduced to a substantially constant degree. Under these conditions, the suck-and-hold planes 52a of the pair of suction pads 52 slightly rises from the state in FIG. 12B to the state in FIG. 12C and further rotate in a counterclockwise direction. Consequently, the clearance between the medicine package 2 at the bottom and the suck-and-hold planes 52a of the pair of suction pads 52, which is caused by difference in angle, is approximately reduced to none, and the medicine package 2 at the bottom is sucked and held by the air suctioning performed by the pair of suction pads 52.

When the medicine package 2 to be taken out from the container 10 is on the bottom face of the container 10, that medicine package 2 is approximately horizontal. In such cases, it is desired that the suck-and-hold planes 52a of the pair of suction pads 52 be horizontal. By contrast, when the front end 4a of the pressure-bonded portion 4 next to the adhered portions 2c of lowermost one of the medicine packages 2 in the container 10 is hooked on the interior wall 11e of the casing 11 of the container 10, the pair of suction pads 52 have to rise higher for sucking operation and the angle of inclination tends to increase as the hooked position is higher. In view of such circumstances, it is desired that the angle be increased proportionate to the degree of intrusion of the pair of suction pads 52.

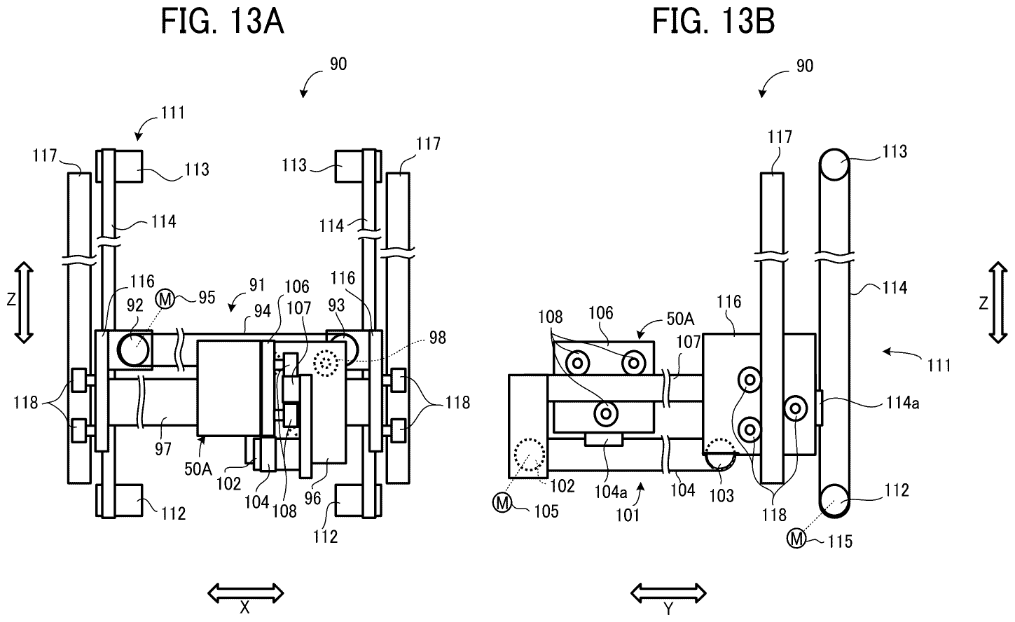

FIG. 13A is a front view of the conveyor 90 illustrating a schematic configuration of the conveyor 90.

FIG. 13B is a side view of the conveyor 90 of FIG. 13A.

As in the configuration or structure of the medication support device 200 illustrated in FIG. 1A and FIG. 1B, the multiple containers 10 are aligned in a row on a plane under the medicine dispensing tray 30 in the Z-axis direction, and the medicine dispensing tray 30 is arranged at an uppermost portion of the housing 199 and further above the upper portion of the containers 10. In view of these circumstances, the pickup unit 50A is configured to move in three directions of the X-axis direction, the Y-axis direction, and the Z-axis direction. As described above, the conveyor 90 moves the pickup unit 50 in the X-axis direction, in the Y-axis direction, and in the Z-axis direction in order to convey one of the multiple medicine packages 2 picked up from one of the containers 10 by the pickup unit 50A and pass it to one of the multiple medicine dispensing trays 30.

The pickup unit 50A is moved in the X-axis direction by an X-axis direction conveyor 91, and the pickup unit 50A is moved in the Y-axis direction by a Y-axis direction conveyor 101. The pickup unit 50A is moved in the Z-axis direction by a Z-axis direction conveyor 111. These three conveyors have a similar configuration or structure.

The X-axis direction conveyor 91 includes an X-adaptor 96 attached to the pickup unit 50A, an X-guide unit 97 that guides the pickup unit 50A in the X-axis direction through the X-adaptor 96, an endless belt 94 looped around a driving pulley 92 and a driven pulley 93, and a drive motor 95 coupled to the driving pulley 92 through a driving force conveyor such as a gear or a belt for the conveyance in the X-axis direction. As illustrated in FIG. 13A, three rollers 98 are attached to the X-adaptor 96 so as to clamp the X-guide unit 97. Due to such a configuration, the X-adaptor 96 can roll over the X-guide unit 97. Note that, in FIG. 13A, two of the three rollers 98 are hidden by the pickup unit 50A. The X-adaptor 96 is fixedly coupled to the endless belt 94 through a belt grip.

When the drive motor 95 is driven to rotate due to the above configuration or structure of the X-axis direction conveyor 91, the driving force is conveyed to the endless belt 94 through the driving force conveyor and the driving pulley 92, and the endless belt 94 runs in rotation. Accordingly, the pickup unit 50A moves in the X-axis direction along X-guide unit 97 together with the X-adaptor 96.

The Y-axis direction conveyor 101 includes a Y-adaptor 106 attached to the pickup unit 50A, a Y-guide unit 107 that guides the pickup unit 50A in the Y-axis direction through the Y-adaptor 106, an endless belt 104 looped around a driving pulley 102 and a driven pulley 103, and a drive motor 105 coupled to the driving pulley 102 through a driving force conveyor such as a gear or a belt for the conveyance in the Y-axis direction. Three rollers 108 are attached to the Y-adaptor 106 so as to clamp the Y-guide unit 107. Due to such a configuration, the Y-adaptor 106 can roll over the Y-guide unit 107. The Y-adaptor 106 is coupled and fixed to the endless belt 104 through the belt grip 104a.

When the drive motor 105 is driven to rotate due to the above configuration or structure of the Y-axis direction conveyor 101, the driving force is conveyed to the endless belt 104 through the driving force conveyor and the driving pulley 102, and the endless belt 104 runs in rotation. Accordingly, the pickup unit 50A moves in the Y-axis direction along Y-guide unit 107 together with the Y-adaptor 106.

The Z-axis direction conveyor 111 includes a pair of Z-adaptors 116 attached to both ends of the X-guide unit 97 in the X-axis direction, a pair of Z-guide units 117 that guides the pickup unit 50A in the Z-axis direction through the X-guide unit 97 and the pair of Z-adaptors 116, a pair of endless belts 114 looped around a pair of driving pulleys 112 and a pair of driven pulleys 113, and a drive motor 115 coupled to one of the pair of driving pulleys 112 through a driving force conveyor such as a gear or belt for the conveyance in the Z-axis direction. In the Z-axis direction conveyor 111, the driving pulley 112, the driven pulley 113, and the endless belt 114 are arranged on both sides in the X-axis direction. The drive motor 115 is provided for only one of the pair of driving pulleys 112. three rollers 118 are attached to each one of the pair of Z-adaptors 116 so as to clamp corresponding one of the pair of Z-guide units 117. Due to such a configuration, the pair of Z-adaptors 116 can roll over the pair of Z-guide units 117, respectively. The pair of Z-adaptors 116 are coupled and fixed to the pair of endless belts 114 through a pair of belt grips 114a, respectively.

When the pair of drive motors 115 are driven to rotate due to the above configuration or structure of the Z-axis direction conveyor 111, the driving force is conveyed to the endless belt 114 through the driving force conveyor and the driving pulley 112, and the endless belt 114 runs in rotation. Accordingly, the pickup unit 50A moves in the Z-axis direction along Z-guide unit 117 together with the X-guide unit 97 and the Z-adaptor 116.

In FIG. 13A and FIG. 13B, the pickup unit 50A moves in the triaxial directions including the X-axis direction, the Y-axis direction, and the Z-axis direction. However, no limitation is indicated thereby. For example, when the container 10 is arranged above the pickup unit 50A and the medicine dispensing tray 30 is arranged below the pickup unit 50A, the pickup unit 50A only needs to move in the X-axis direction and the Y-axis direction. In such cases, the number of axes of motion can be reduced by one.

In the structure or configuration of the conveyor 90 as illustrated in FIG. 13A and FIG. 13B, the front end of the Y-guide unit 107 in the Y-axis direction is not held. In order to handle such a situation, as illustrated in FIG. 14, a roller 126 may be arranged to hold the front end 107a of the Y-guide unit 107 at the front end of the bracket 125 to which the front end 107a of the Y-guide unit 107 is attached and supported, and the roller 126 may be arranged on a bearer 122 provided for the housing 199 in a rollable manner.

Due to the above configuration, the front end 107a of the Y-guide unit 107 can be prevented from being bent by its own weight. This reduces a variation in the distance between the pickup unit 50 and the container 10 or the distance between the pickup unit 50 and the medicine dispensing tray 30, and the medicine package 2 can be picked up in a stable manner and the medicine package 2 can be inserted into the medicine dispensing tray 30 in a stable manner.

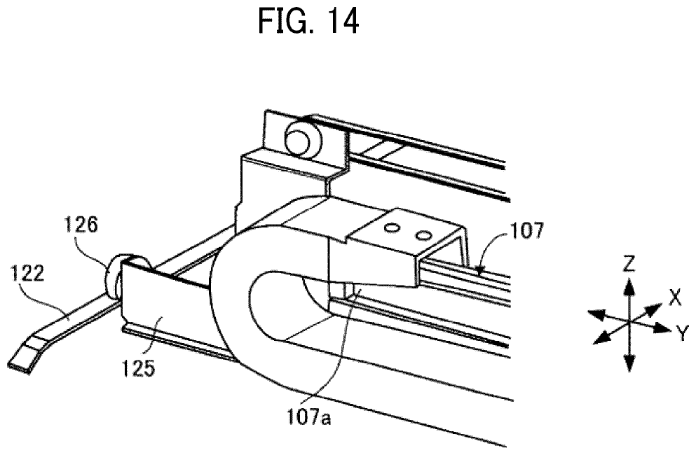

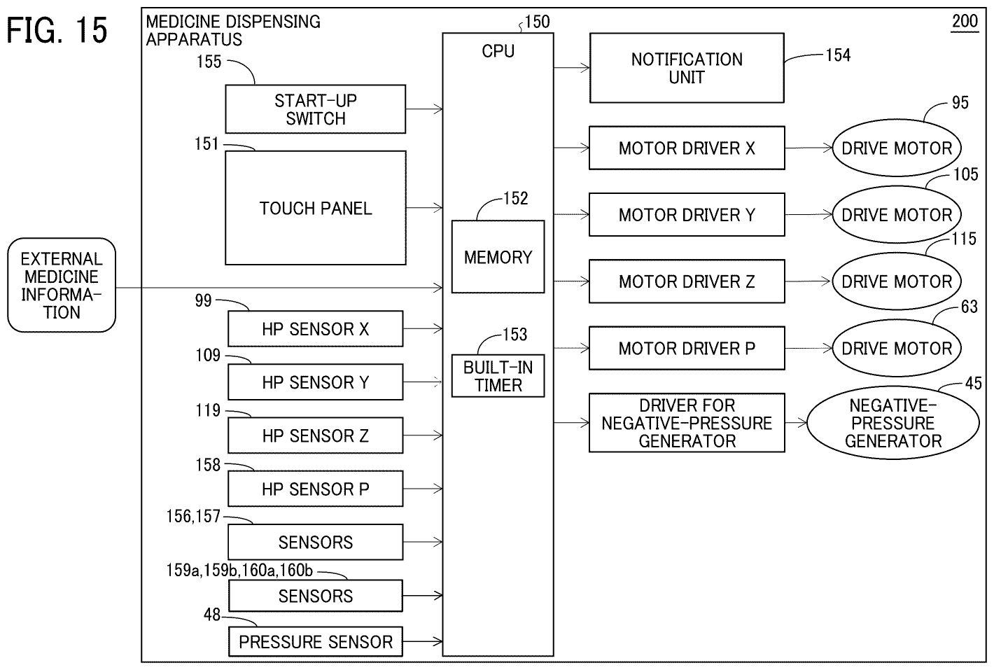

FIG. 15 is a block diagram illustrating a schematic control structure for the medication support device 200, according to the first comparative example. As illustrated in FIG. 15, the medication support device 200 includes a central processing unit (CPU) that is an example of a controller 150 that controls the operation of, for example, the components or elements of the medication support device 200. For example, the CPU may be provided with a built-in memory 152 or a built-in timer 153. The CPU according to the present embodiment may provide notification to, for example, a user including staff or the like at a timing consistent with the program or may instruct the medication support device 200 to perform particular operation, based on various kinds of input such as the inputs from a sensor as will be described later in detail. To the built-in memory 152, prescription data or medicine information are externally input as external medicine information.

The CPU may have, for example, a computing or control function, and a timer or clocking function. The built-in memory 152 includes a read-only memory (ROM), a random access memory (RAM), and an external memory. The ROM according to the present embodiment stores, for example, a program readable by the above CPU and various kinds of data in advance. Such a program stored in the ROM may be a program used in the flowchart of the controlling processes as will be described later in detail. The above various kinds of data may be, for example, the data about the relation between the medicine packages 2 and the rooms 33 or the subdivision boxes 34 of one of the medicine dispensing trays 30 allocated to each of the patients who take medicines, the data about the relation between the medicine packages 2 and the multiple rooms 33 or the multiple subdivision boxes 34 of one of the medicine dispensing trays 30 assigned to each one of the times of medication, or the data about the relation between the medicine packages 2 and the rooms 33 or the subdivision boxes 34 of one of the medicine dispensing trays 30 sorted according to the order in which medicines are to be taken (see, for example, FIG. 3).

The CPU has an input and output (I/O) port, and a touch panel 151 that is an example of a user interface (UI) and an operation panel provided with an input unit and a display unit is electrically connected to that input and output port of the CPU. Through the touch panel 151, various kinds of inputs can be made, and for example, the current time, the progress of the storing process of packs, or the stop time are displayed on the touch panel 151. How such inputs are made or the structure or configuration of such a display unit are not limited thereto, and may be, for example, an input unit and a display unit may be arranged separately. Alternatively, a combination of an input device and a display interface such as a combination of a keyboard and a light-emitting diode (LED) display may be adopted.

To the input port of the CPU, a start-up switch 155 that drives the medication support device 200 to operate is electrically connected. Once the start-up switch 155 is touched or pressed down, medicine dispensing operation to the medicine dispensing trays 30 starts step by step. The medicine dispensing operation to the medicine dispensing trays 30 may start at a time determined in advance by the built-in timer 153. The CPU according to the present embodiment has an input port, and a medicine dispensing tray sensor 156 that detects the type of medicine dispensing tray 30 stored in the medication support device 200 or determines whether or not there is any medicine dispensing tray 30, and a container sensor 157 that determines whether or not there is any one of the multiple containers 10 are electrically connected to the input port of the CPU.

As various types of sensors, a pair of container gate opening and closing sensors 159a and 159b that detect the opening and closing of the first gate 41 and the second gate 42 and a pair of medicine dispensing tray gate opening and closing sensors 160a and 160b that detect the opening and closing of the third gate 43 and the fourth gate 44 are electrically connected to the input port of the CPU. The medicine dispensing tray sensor 156, the container sensor 157, the pair of container gate opening and closing sensor 159a and 159b, and the pair of medicine dispensing tray gate opening and closing sensors 160a and 160b are illustrated only in FIG. 15.

To the input port of the above CPU, a home position (HP) sensor 99 that is used for a home position (HP) sensor X to detect the home position (HP) of the X-axis direction conveyor 91 in the pickup unit 50, an HP sensor 109 that is used for an HP sensor Y to detect the home position (HP) of the Y-axis direction conveyor 101 in the pickup unit 50, and an HP sensor 119 that is used for an HP sensor Z to detect the home position (HP) of the Z-axis direction conveyor 111 in the pickup unit 50 are electrically connected.

Moreover, to the input port of the CPU, a home position (HP) sensor 158 for a HP sensor P that detects the home positions (HP) of the pair of suction pads 52 of the suction device 51 in the pickup unit 50 is electrically connected. Further, to the input port of the above CPU, a pressure sensor 48 provided for the air tube 49 arranged between the negative-pressure generator 45 and the suction device 51 to measure the negative pressure is electrically connected.

To the output port of the above CPU, the drive motor 95 for the X-axis direction conveyor 91, the drive motor 105 for the Y-axis direction conveyor 101, the drive motor 115 for the Z-axis direction conveyor 111, and the drive motor 63 used to change the posture or attitude of the pair of suction pads 52 are electrically connected to the input port of the CPU through various kinds of motor drivers X, Y, Z, and P, respectively. Moreover, to the output port of the above CPU, the negative-pressure generator 45 that is an example as an ejector valve and an actuator used for the negative pressure generator is electrically connected through a driver used for a negative-pressure generator. To the output port of the CPU, a notification unit may be electrically connected. Such a notification unit reports what sort of state or conditions the components or elements of the medication support device 200 are in by means of, for example, the light emitted from a light-emitting diode (LED) and the sound or vibration including voice. Moreover, such a notification unit may be provided with, for example, a loudspeaker or a light that indicates that the medicines are to be taken so that the staff or the like away from the medication support device 200 can be notified of such a time of medication.

The external medicine information is also input to the CPU through an input and output (I/O) interface, and is stored in the built-in memory 152. For example, the external medicine information is used for the allocation of medicines to patients who take medicines. For example, the LEDs 25al to 25d5 of the drawer 80 may be electrically connected to each other.

Once the input data from the touch panel 151 and various kinds of signals from various types of sensors or the HP sensors 99, 109, 119, and 158 are input to the CPU, a command signal is newly output from the CPU. In other words, the CPU according to the present embodiment outputs a command signal used to control the audio device or the optical device of the display device of the touch panel 151 including the above notification unit, the LEDs 25al to 25d5, the drive motor 63, the drive motor 95, the drive motor 105, the drive motor 115, or the multiple drives that correspond to the multiple LEDs.

The HP sensor 158 for the HP sensor P and the drive motor 63 that outputs power through the motor driver P are used to control or drive the mechanism for moving the suction device to move upward and downward. The CPU according to the present embodiment executes various kinds of control operation as will be described later in detail in the following description or the flowchart of the controlling processes.

An overall operation of the medication support device 200 according to the first comparative example is described below with reference to FIG. 9A to FIG. 11B and FIG. 16A to FIG. 17B.

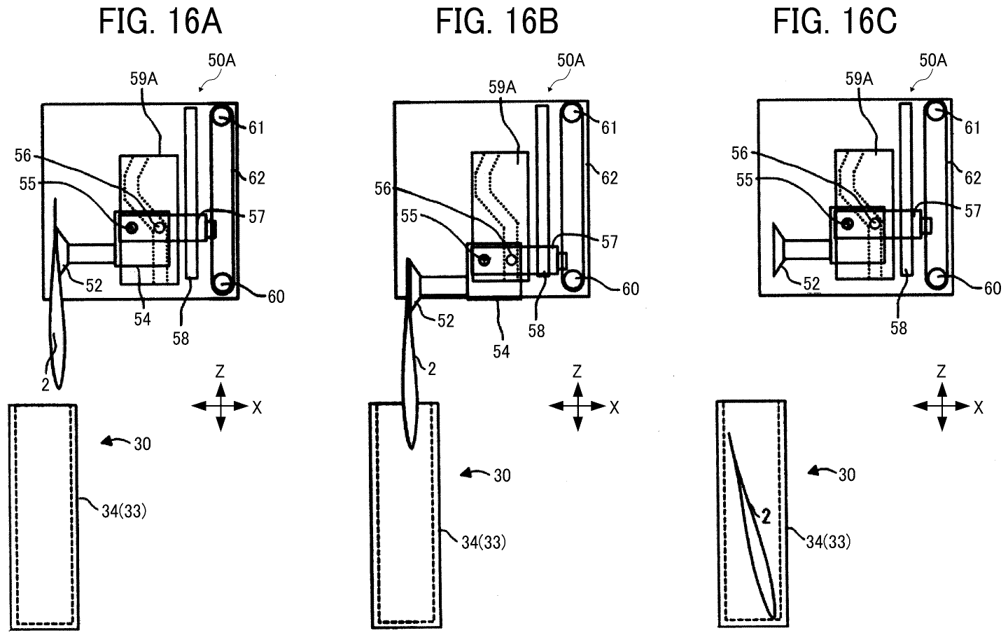

FIG. 16A to FIG. 16C are diagrams illustrating an operation in which the medicine packages 2 are dispensed to the subdivision boxes 34 of the medicine dispensing tray 30 in the medication support device 200 according to the first comparative example.

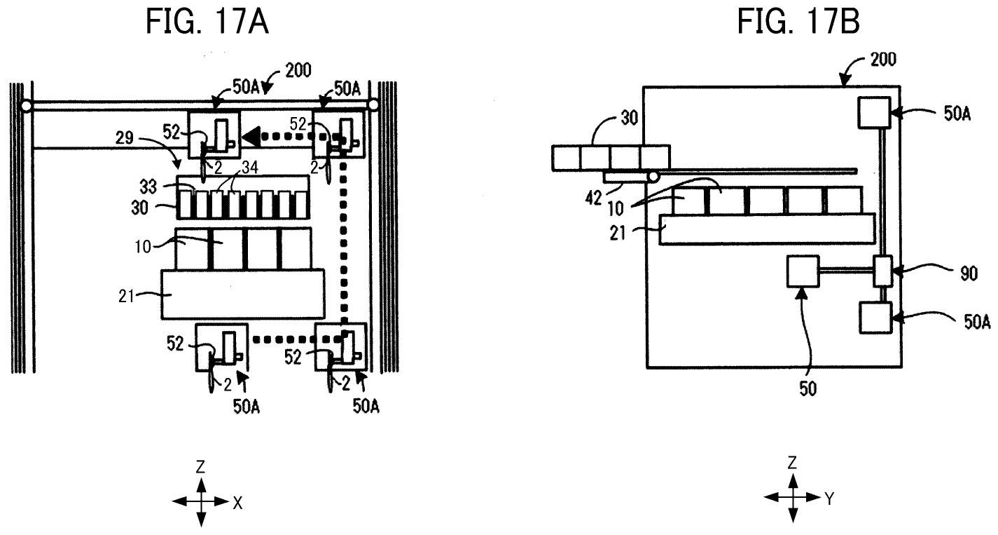

FIG. 17A and FIG. 17B are diagrams illustrating the overall operation performed in the medication support device 200 according to the first comparative example.

These operations described with reference to FIG. 9A to FIG. 11B and FIG. 16A to FIG. 17B are executed under the control commands from the CPU of the controller 150 described as above with reference to FIG. 15. As described above with reference to FIG. 9A to FIG. 10A, a pick-out operation is performed to pick up one of the medicine packages 2 from the container 10. In so doing, as described above with reference to FIG. 10A, by the reverse operation of the drive motor 63, the pair of suction pads 52 move downward while sucking the medicine package 2 at the bottom of the container 10 by the pair of suction pads 52, and the front end of one of the medicine packages 2 is pulled out from the container 10. The front end of the medicine package indicates a of the medicine package to be absorbed or sucked up by the pair of suction pads 52.

Subsequently, as illustrated in FIG. 10B, by the operation of the conveyor 90, the pickup unit 50A is moved in the X-axis direction, which is the lateral direction, and the rear end of one of the multiple medicine packages 2 is drawn out or picked up from one of the multiple containers 10. Immediately after that, as illustrated in FIG. 11A and FIG. 11B, by the operation of the drive motor 63, one of the multiple medicine packages 2, which is approximately in a horizontal state and is sucked and held by the pair of suction pads 52, is rotated by substantially 90 degrees to change the posture to an approximately vertical or upright posture. In such rotational operation, the guide axis 56 that is arranged on the suction-pad supporting member 54 moves along the guide grooves 59b on the guide unit 59A. Accordingly, the posture of one of the multiple medicine packages 2 can be changed from an approximately horizontal posture to an approximately vertical posture. The above series of operation in the above configuration may be achieved by a series of operation performed by a single drive motor 63.

Subsequently, as illustrated in FIG. 16A to FIG. 17B, placing operation is performed in which the medicine package 2 is dispensed to a desired one of the rooms 33 or the subdivision boxes 34 of the medicine dispensing tray 30. After the above pick-out operation is completed, the pickup unit 50A is moved by the conveyor 90 to a position above a desired one of the rooms 33 or the subdivision boxes 34 of the medicine dispensing tray 30 while the pair of suction pads 52 are sucking and holding the medicine package 2 vertically (see, for example, FIG. 16A).

As illustrated in FIG. 17A, the medicine package 2 that has been taken out is held by the pair of suction pads 52 of the pickup unit 50A in the same posture as that illustrated in FIG. 11B. The pickup unit 50A that includes the pair of suction pads 52 and holds one of the medicine packages 2 is conveyed by the conveyor 90 along the route indicated by thick broken lines to the medicine dispensing position 29 where medicine dispensing trays 30 are arranged. When the pickup unit 50A is carried to a position substantially directly above the medicine dispensing trays 30 at the medicine dispensing position 29, as illustrated in FIG. 16B, FIG. 16C, and FIG. 17A, the negative pressure generated by the negative-pressure generator 45 is released to terminate suctioning and send out the air. As a result, the hold of the medicine package 2 by the pair of suction pads 52 is released. Accordingly, the suction holding of one of the multiple medicine packages 2 by the pair of suction pads 52 is released, and one of the medicine packages 2 is inserted into a desired one of the multiple subdivision boxes 34 or a desired one of the multiple rooms 33 of the medicine dispensing trays 30. After the above-described operation is performed several times and a desired one of the medicine packages 2 is inserted into one of the multiple rooms 33 or the subdivision boxes 34 that is at a predetermined position of one of the multiple medicine dispensing trays 30, as illustrated in FIG. 17B, one of the multiple medicine dispensing trays 30 is ejected to the outside of the medication support device 200 through, for example, the second gate 42, and is received by a staff or the like in a day-care center or nursing home or a medication assistant.

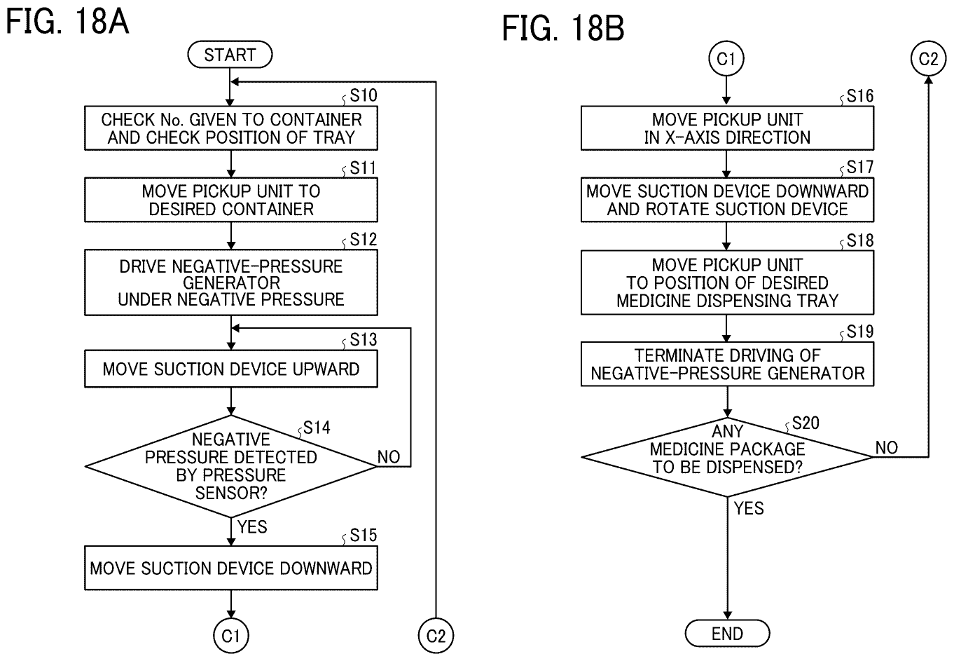

With reference to FIG. 18A and FIG. 18B, supplemental description is given for the operation of the pickup unit 50A in an overall operation flow of FIG. 17A and FIG. 17B.

FIG. 18A and FIG. 18B are flowcharts of the operation of the pickup unit 50A according to the first comparative example. Firstly, in step S10 of FIG. 18A and FIG. 18B, the number (No.) given to the container 10 that is an object in which the medicine package 2 to be dispensed is stored is checked, and the position of the medicine dispensing tray 30 that is an object to which the medicine package 2 is to be passed is checked. Then, in step S11, the pickup unit 50A is moved to desired one of the containers 10 by the conveyor 90. Subsequently, in order to implement the operation illustrated in FIG. 9B and FIG. 9C, in step S12, the drive motor 63 is driven to rotate while the negative-pressure generator 45 is being driven to generate negative pressure. By so doing, in step S13, the suction device 51 is moved upward. The pressure sensor 48 detects negative pressure to determine whether the medicine package 2 at the bottom of the container 10 is sucked up by the pair of suction pads 52. When sucking up of the medicine package 2 is not detected in step S14, the suction device 51 is lifted further upward in step S13. When the pressure sensor 48 detects the negative pressure and detects sucking up of the medicine package 2, in step S14 and step S15, the drive motor 63 is driven in inverse direction so as to move the suction device 51 downward. Subsequently, in step S16, the pickup unit 50A is moved in the X-axis direction, and desired one of the multiple medicine packages 2 is completely taken out from one of the multiple containers 10. Then, in step S17, the drive motor 63 is further driven to rotate in the reverse direction so as to move the suction device 51 downward. As a result, the suction device 51 is rotated by approximately 90 degrees, and the posture of the medicine package 2 is changed from an approximately parallel or horizontal posture to an approximately vertical posture.

Subsequently, in step S18, the pickup unit 50A is moved to a desired position of one of the multiple medicine dispensing trays 30 by the conveyor 90. When the pickup unit 50A has moved to the position of desired one of the multiple medicine dispensing trays 30, the operation of the negative-pressure generator 45 is switched to terminate generating negative pressure and start generating positive pressure. By so doing, the medicine package 2 is released and separated from the pair of suction pads 52. Then, in step S19, the driving of the negative-pressure generator 45 is terminated. In step S20, whether there is any medicine package 2 to be dispensed is checked. When there is no medicine package 2 to be dispersed, a series of operation is terminated. On the other hand, when it is determined in the step S20 that there is at least one medicine package 2 to be dispensed, the process is returned to the step S10, and the same series of processes in the above steps are repeated.

In the first comparative example, the suction-pad supporting member 54 of the suction device 51 is rotated using the guide unit 59A and the guide axis 56 to change the angle of the pair of suction pads 52. With such a configuration and operation, a medication support device in which the medicine packages 2 can be sucked up even if some of the medicine packages 2 is inclined and stored in the container 10 can be provided at low cost. In the first comparative example, when desired one of the multiple medicine packages 2 is picked up from one of the multiple containers 10, the pickup unit 50A is positioned or arranged under one of the multiple containers 10, and such desired one of the multiple medicine packages 2 is taken out in the downward direction of one of the multiple containers 10. When one of the medicine packages 2 is taken out from the lower side of one of the containers 10 as described above, the next one of the medicine packages 2 automatically moves downward or toward the pack pickup slot 17 due to the self weight of the movable board 16 and the medicine packages 2 left in the container 10. Due to such a configuration, the pickup unit 50A can perform the same operation with a relatively simple configuration regardless of the number of the medicine packages 2 left in the container 10.

According to the first comparative example as described above, when the pair of suction pads 52 that are examples of a suction device are inclined at the inner bottom of the container 10, the angle of the suck-and-hold planes 52a of the pair of suction pads 52 is changed in accordance with that inclination. Due to such a configuration, the clearance between the medicine package at the bottom and the suction unit is approximately reduced to none, and suctioning can be done with reliability.

In the first comparative example, when desired of the multiple medicine packages 2 is picked up from one of the multiple containers 10, the pickup unit 50A is positioned or arranged under one of the multiple containers 10, and such desired one of the multiple medicine packages 2 is taken out in the downward direction of one of the multiple containers 10. Moreover, the pickup unit 50A can perform the same operation with a relatively simple configuration regardless of the number of the multiple medicine packages 2 left in the containers 10.

### Second Comparative Example

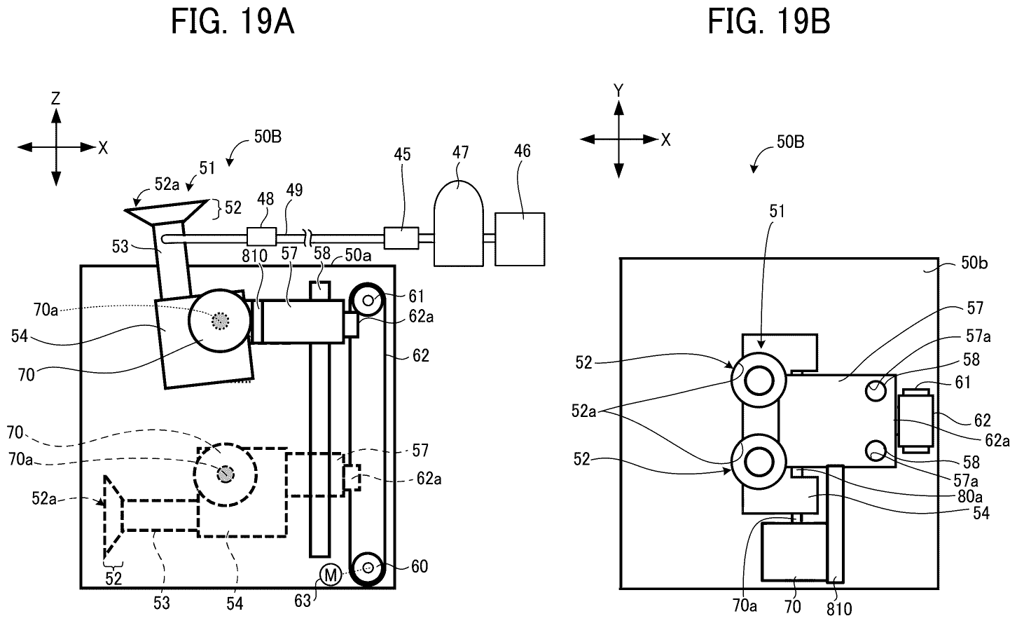

FIG. 19A is a front view of a pickup unit 50B, illustrating a configuration or structure of the pickup unit 50B of the medication support device 200 according to the second comparative example, which may be referred to as the pickup unit 50B according to the second comparative example in the following description.

FIG. 19B is a plan view of the pickup unit 50B of FIG. 19A.

The medication support device 200 according to the second comparative example is different from the above pickup unit 50A according to the first comparative example in that the former is provided with the pickup unit 50B as illustrated in FIG. 19A and FIG. 19B in place of the pickup unit 50A according to the first comparative example illustrated in FIG. 7A and FIG. 7B. The pickup unit 50B according to the second comparative example is equivalent to the above pickup unit 50A according to the first comparative example except the above-mentioned difference.

As described above, the pickup unit 50A according to the first comparative example is implemented by a linking mechanism and the guide unit 59A formed with the guide groove 59b. Compared with the pickup unit 50A according to the first comparative example, in the pickup unit 50B according to the second comparative example, these elements such as the guide unit 59A and the guide axis 56 are eliminated. In place of such eliminated elements, in the second comparative example, the angle changing mechanism of the suction device is implemented by the suction device angle changing motor 70 that is an example of an actuator. The pickup unit 50B according to the second comparative example is equivalent to the above pickup unit 50A according to the first comparative example except the above-mentioned difference.

In the pickup unit 50B, the posture or attitude of the suction-pad supporting member 54 and the suction device 51 is changed by the suction device angle changing motor 70 through the rotary shaft 55. The suction device angle changing motor 70 is fixed to the suction device base 57 through a motor attaching component 810 fixed to the suction device base 57. The suction device angle changing motor 70 has an output shaft 70a is directly fixed to the suction-pad supporting member 54 in place of the rotary shaft 55 provided for the suction-pad supporting member 54. The suction device angle changing motor 70 includes a stepping motor driven by pulse input or the like.

By a pulse input of a predetermined number of steps to the suction device angle changing motor 70, the posture or attitude of the suction device 51 including the pair of suction pads 52, the suction duct 53, and the suction-pad supporting member 54, which is indicated by solid lines in FIG. 19A, is made equivalent to the posture or attitude of the suction device 51 including the pair of suction pads 52, the suction duct 53, and the suction-pad supporting member 54 according to the first comparative example illustrated in FIG. 17A. In such posture or attitude, the suck-and-hold planes 52a of the pair of suction pads 52 are inclined toward the bottom left to suck and hold the medicine package 2 at the bottom of the container 10. By a pulse input of a predetermined number of steps to the suction device angle changing motor 70, the posture or attitude of the suction device 51 as indicated by dot-and-dash line in FIG. 19A is made equivalent to the posture or attitude of the suction device 51 including the pair of suction pads 52, the suction duct 53, and the suction-pad supporting member 54 according to the first comparative example illustrated in FIG. 9A or FIG. 11B. In such posture or attitude, the suck-and-hold planes 52a of the pair of suction pads 52 are inclined approximately vertical, and the posture or attitude of the pack has already been changed.

By a pulse input of a predetermined number of steps to the suction device angle changing motor 70 in the above configuration or structure according to the second comparative example, substantially the same posture or attitude as that of the suction device 51 according to the first comparative example described above with reference to FIG. 9A to FIG. 16B can be employed. The progression of the operation in the second comparative example is also equivalent to that of the first comparative example described as above. When a typical stepper motor is adopted as the suction device angle changing motor 70, for example, it is desired that an HP sensor be arranged to deal with a step-out.

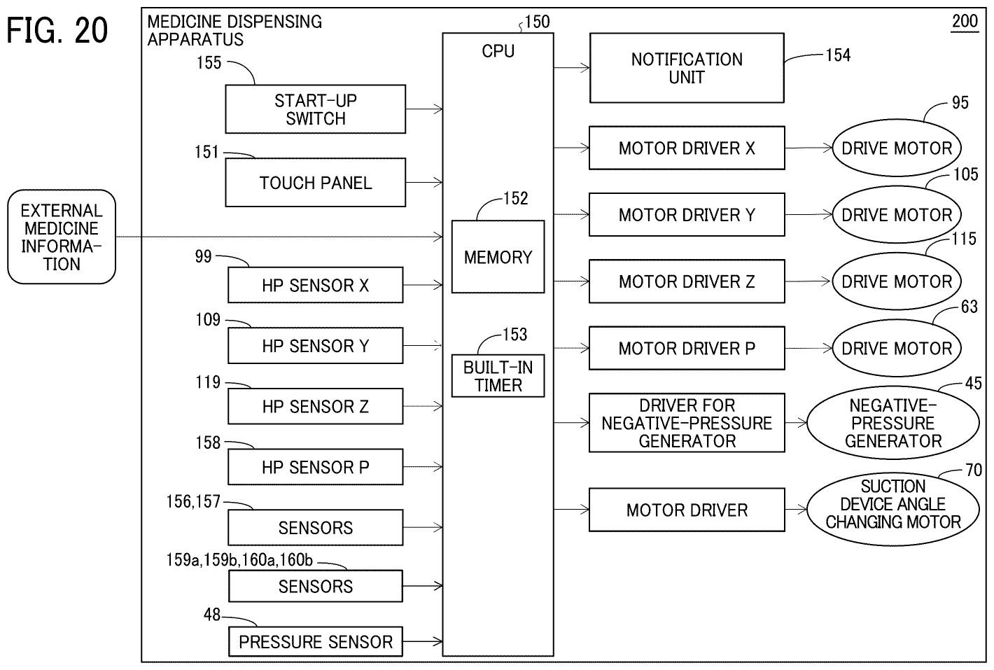

A control structure for the medication support device 200 according to the second comparative example is described below with reference to FIG. 20. FIG. 20 is a block diagram illustrating a schematic control structure for the medication support device 200, according to the second comparative example. The control structure of the medication support device according to the second comparative example is different from the control structure according to the first comparative example as illustrated in FIG. 15 in that the suction device angle changing motor 70 is electrically connected to the output port of the CPU through a motor driver.

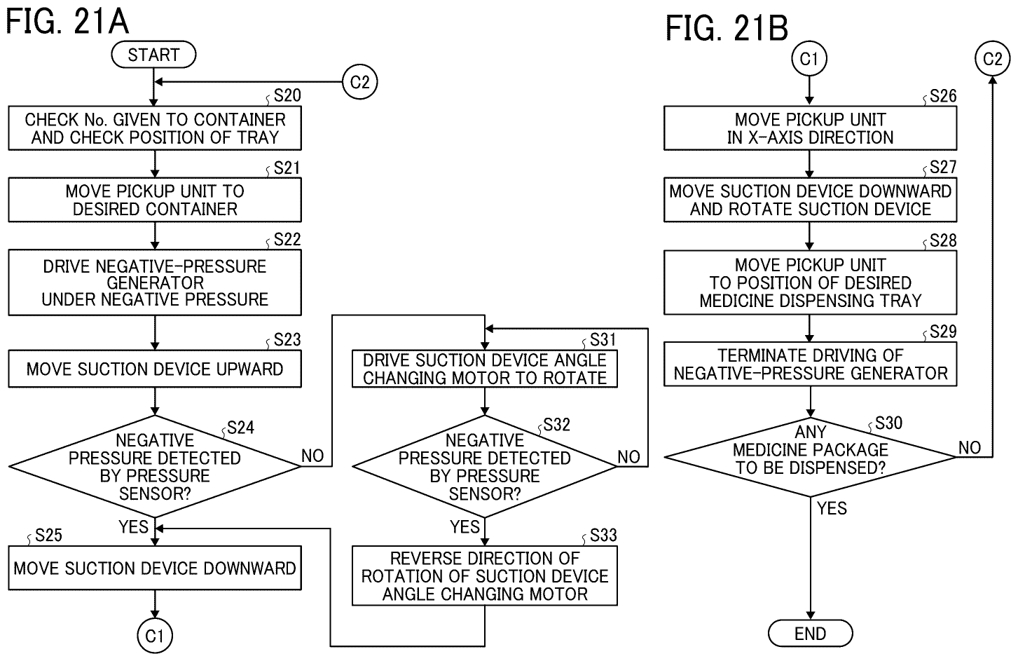

FIG. 21A and FIG. 21B are flowcharts of the operation of the pickup unit 50B according to the second comparative example.

Firstly, in step S20 of FIG. 21A, the number (No.) given to the container 10 that is an object in which the medicine package 2 to be dispensed is stored is checked, and the position of the medicine dispensing tray 30 that is an object to which the medicine package 2 is to be passed is checked. Then, in step S21, the pickup unit 50B is moved to desired one of the containers 10 by the conveyor 90. Subsequently, in step S22, the drive motor 63 is driven while the negative-pressure generator 45 is being driven to generate negative pressure. As a result, in step S23, the suction device 51 moves upward.

Subsequently, in step S24, the pressure sensor 48 detects the negative pressure to determine whether the medicine package 2 at the bottom of the container 10 is sucked up by the pair of suction pads 52. When it is determined that the medicine package 2 at the bottom of the container 10 is sucked up by the pair of suction pads 52 (YES in step S24), in step S25, the suction device 51 is moved downward. By contrast, when sucking up of the medicine package 2 is not detected in step S24 (NO in step S24), in step S31, the suction device angle changing motor 70 is driven to rotate, and the suction device 51 is driven to rotate toward the left in a counterclockwise direction to change its angle. When the pressure sensor 48 detects sucking up of the medicine package 2, in step S33, the direction of rotation of suction device angle changing motor 70 is reversed, and then the drive motor 63 is driven in the inverse direction. Accordingly, in step S25, the suction device 51 moves downward. Subsequently, in step S26, the pickup unit 50B is moved in the X-axis direction, and desired one of the multiple medicine packages 2 is completely taken out from one of the multiple containers 10. Then, in step S27, the drive motor 63 is further driven to rotate in the reverse direction so as to move the suction device 51 downward. As a result, the suction device 51 is rotated by approximately 90 degrees, and the posture of the medicine package 2 is changed from an approximately parallel or horizontal posture to an approximately vertical posture. Subsequently, the pickup unit 50B is moved to a desired position of one of the multiple medicine dispensing trays 30 by the conveyor 90. In step S28, the pickup unit 50B has moved to the position of desired one of the multiple medicine dispensing trays 30, and the medicine package 2 is released and separated from the pair of suction pads 52 while the negative-pressure generator 45 is being driven to generate positive pressure. Subsequently, in step S29, the driving of the negative-pressure generator 45 is terminated. Then, in step S30, whether there is any medicine package 2 to be dispensed is checked. When there is no medicine package 2 to be dispersed, a series of operation is terminated. On the other hand, when it is determined in the step S30 that there is at least one medicine package 2 to be dispensed, the process is returned to the step S20, and the same series of processes in the above steps are repeated.

According to the second comparative example as described above, a driving source can change the angle of the suction device at any desired timing and angle using an actuator including a suction device angle changing motor, and a wider range of angles can be handled with greater reliability.

### Third Comparative Example

A third comparative example is described below. In addition to the configuration or structure according to the first comparative example or the second comparative example, in the third comparative example, a suction sensor is provided that senses how a medicine package is sucked by a suction device such as the pair of suction pads 52. How a medicine package is sucked is sensed using, for example, a vacuum pressure sensor as a suction sensor. In so doing, the CPU has the function of controlling, based on a signal sent from the suction sensor, the drive motor 63 or the suction device angle changing motor 70, which is a driver to change an extent to which the suction device has entered the container so as to change at least one of the changes in angle and the extent to which the suction device has entered the container. In the first comparative example or the second comparative example, the suction sensor is continuously monitored when sucking operation is performed, and as soon as sucking operation is detected, the suction device 51 is moved downward to implement the pulling-out operation of the suction device 51.

According to the third comparative example, the suction sensor senses how a medicine package is sucked, and sucking operation of the medicine package can be done with the shortest length of time in view of a result of such sensing.

According to the third comparative example as described above, as soon as the suction device sucks up a medicine package, the suction device 51 can be moved downward to implement the pulling-out operation of the suction device 51. This enables the medicine package to be picked up from the container with the shortest length of time.

### Embodiments

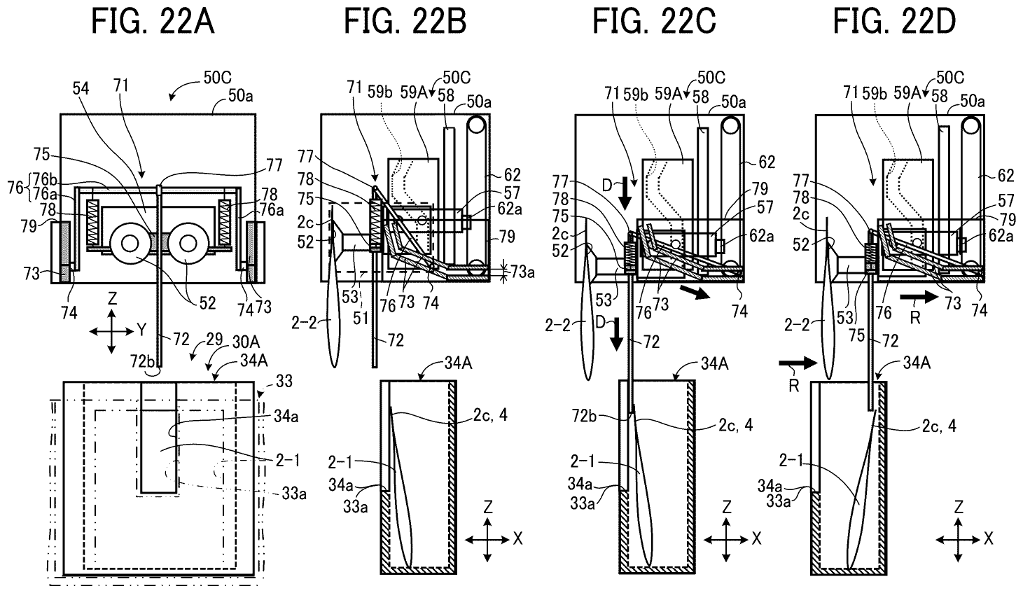

Embodiments of the present disclosure are described below with reference to FIG. 22A to FIG. 27B.

FIG. 22A is a side view of a pickup unit 50C, illustrating a configuration and operation to dispense a pack to the subdivision box 34 and align the dispensed pack therein using a jogger mechanism 71 provided for a pickup unit 50C according to an embodiment.

FIG. 22B to FIG. 22D are front views of the pickup unit 50C, illustrating the progression of the operation to dispense a pack to the subdivision box 34 and align the dispensed pack therein using the same jogger mechanism 71.

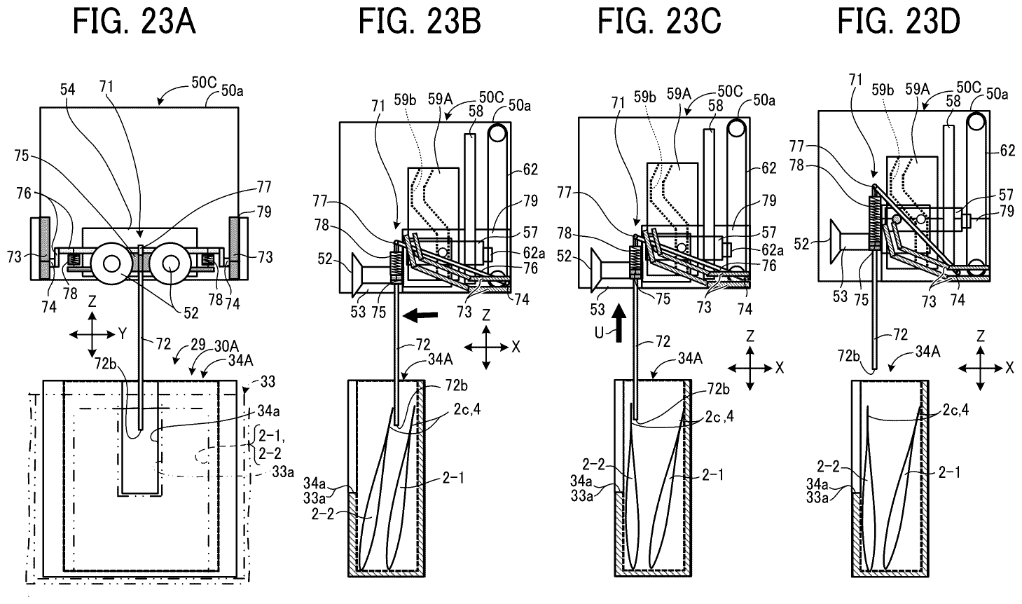

FIG. 23A is a side view of the pickup unit 50C, illustrating the operation of the pickup unit 50C performed subsequent to FIG. 22D.

FIG. 23B to FIG. 23D are front views of the pickup unit 50C, illustrating the progression of the operation to dispense a pack to the subdivision box 34 and align the dispensed pack therein using the same jogger mechanism 71.

In FIG. 22A to FIG. 23D, a guide fixing member 79 to which the pair of guide units 73 are fixed are illustrated outside the picking-up frame 50a. For the sake of explanatory convenience, even if the guide fixing member 79 overlaps with other elements, in some of these drawings, the guide fixing member 79 is illustrated with solid lines and those solid lines intersect with the lines of other elements.

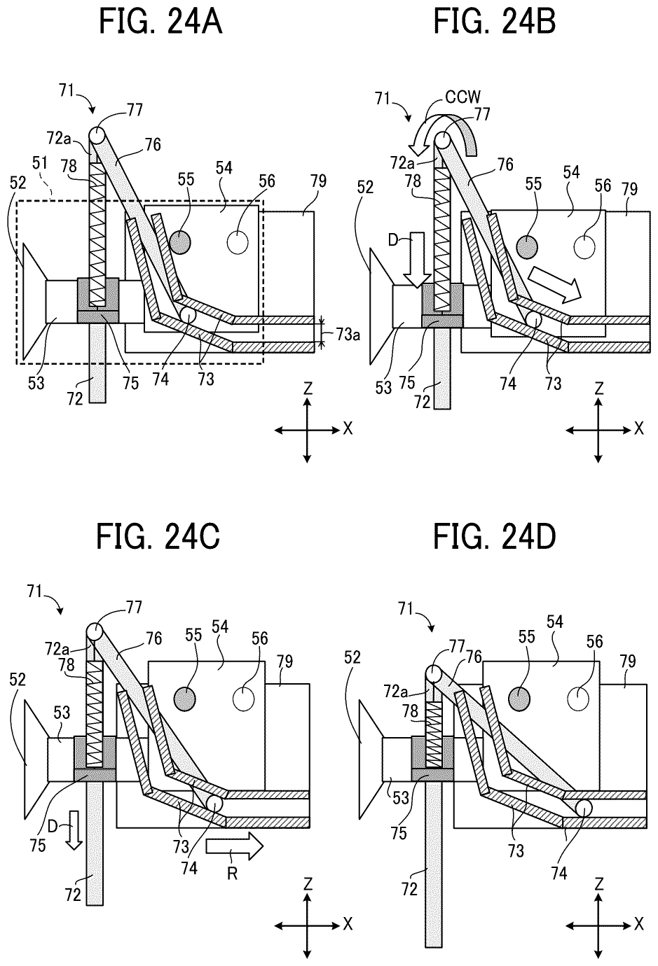

FIG. 24A to FIG. 24D are magnified front views of the pickup unit 50C, which correspond to FIG. 22B to FIG. 22D, illustrating the progression of the operation of the suction device 51 and the jogger mechanism 71.

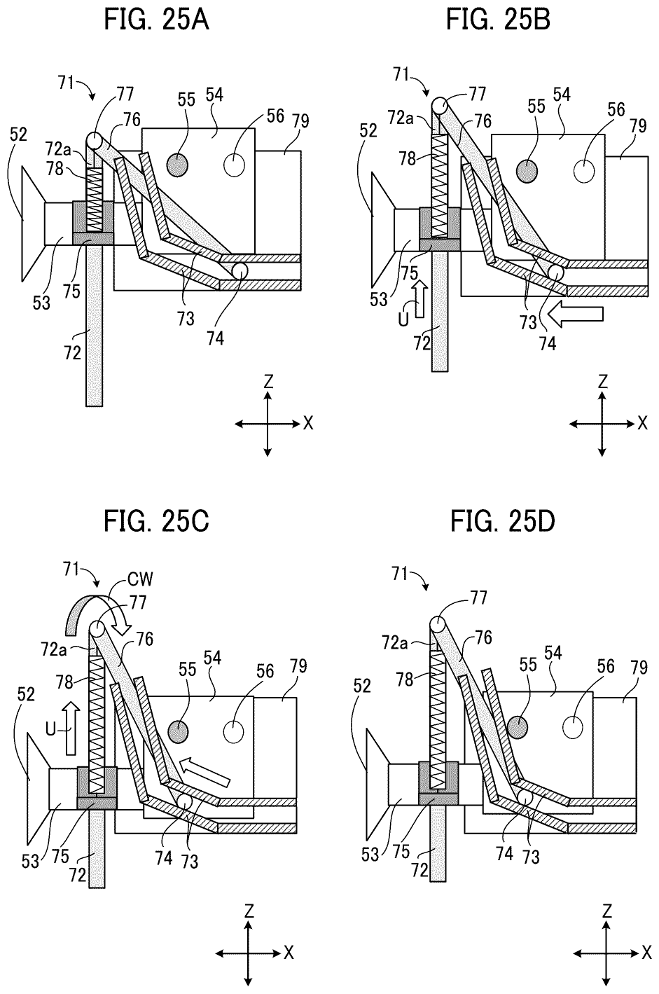

FIG. 25A to FIG. 25D are magnified front views of the pickup unit 50C, which correspond to FIG. 23B to FIG. 23D, illustrating the progression of the operation of the suction device 51 and the jogger mechanism 71.

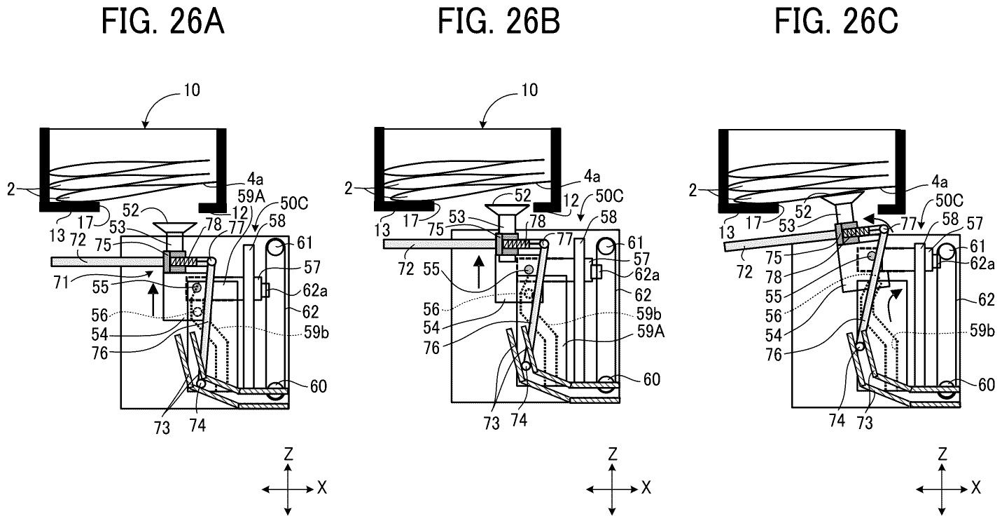

FIG. 26A to FIG. 26C are front views of a pickup unit according to an embodiment, illustrating the progression of the operation of the pickup unit.

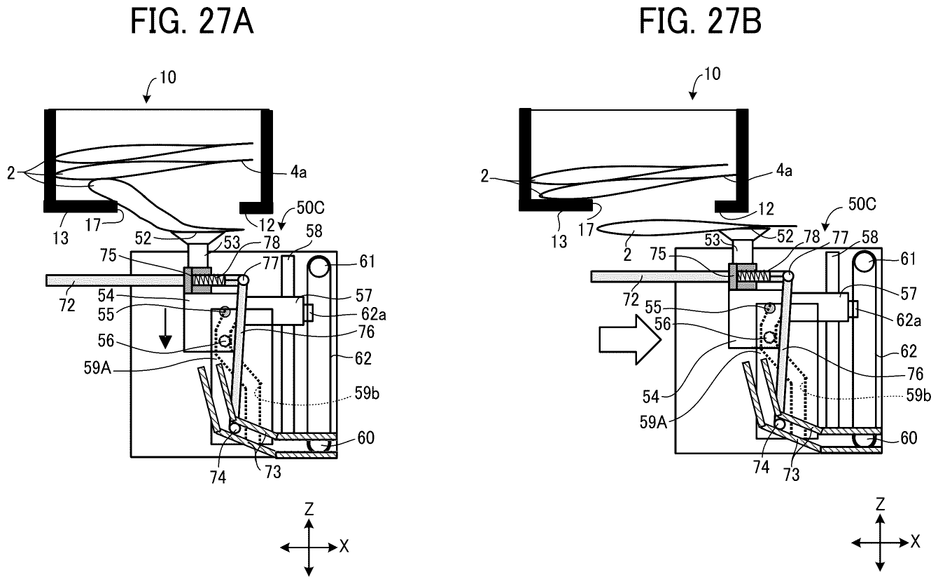

FIG. 27A and FIG. 27B are front views of a pickup unit according to the first embodiment, illustrating the progression of the operation of the pickup unit, following FIG. 26A and FIG. 26C.

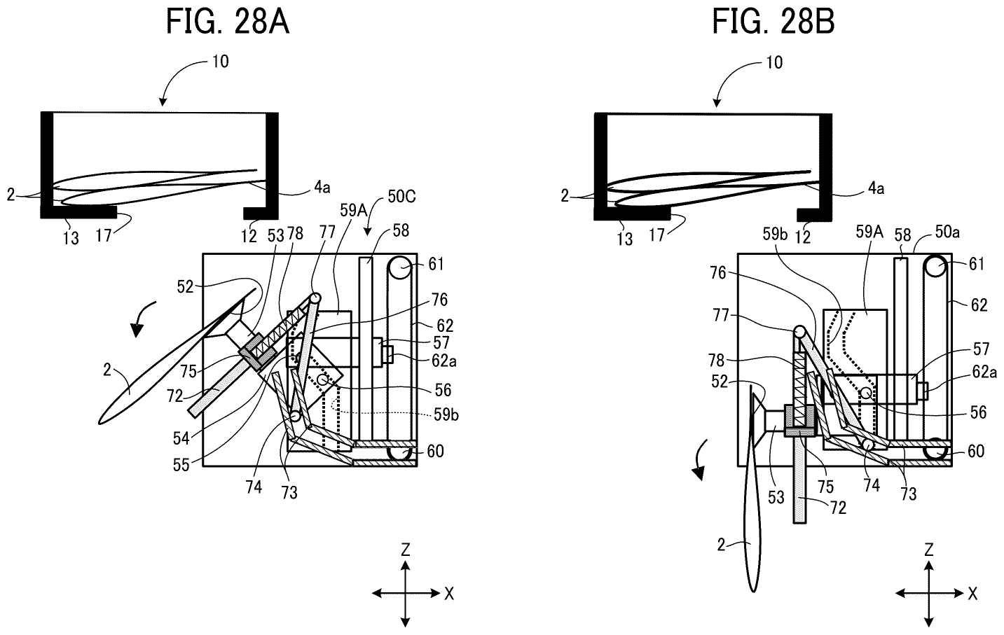

FIG. 28A and FIG. 28B are front views of a pickup unit according to the first embodiment, illustrating the progression of the operation of the pickup unit, following FIG. 27A and FIG. 27B.

A configuration and operation of the pickup unit 50C of the medication support device 200 according to the present embodiment are described below with reference to FIG. 22A to FIG. 25D. In the pickup unit 50C according to the present embodiment, compared with the first comparative example described as above with reference to FIG. 7A and FIG. 7B, additional operations are implemented in the first embodiment.

The pickup unit 50C according to the present embodiment as illustrated in FIG. 22A to FIG. 22D and FIG. 23 is different from the pickup unit 50A according to the first comparative example as illustrated in FIG. 7A and FIG. 7B in that the pickup unit 50C as illustrated in FIG. 24A to FIG. 24D and FIG. 25A to FIG. 25D involves the jogger mechanism 71. The pickup unit 50C according to the present embodiment is equivalent to the pickup unit 50A according to the first comparative example except the above-mentioned difference, and has a similar control structure (see the control blocks in FIG. 15).

Compared with the pickup unit 50A according to the first comparative example, the pickup unit 50C according to the present embodiment involves the jogger mechanism 71 to perform a specific operation as illustrated in FIG. 22A to FIG. 25D. Elements of the jogger mechanism 71 are described below with reference to the magnified views in FIG. 22A, FIG. 22B, and FIG. 24A. In each of FIG. 22B and FIG. 24A, the area surrounded by dashed lines indicates the initial position of the suction device 51.

As illustrated in FIG. 22A, FIG. 22B, and FIG. 24A, the jogger mechanism 71 includes a jogger base 72, a jogger guide 75, a pair of upper and lower guide units 73, a coupler 76, a pair of pulling springs 78, and a rotary coupler 77. The jogger base 72, the jogger guide 75, the pair of upper and lower guide units 73, the coupler 76, and the rotary coupler 77 are made of, for example, resin or metal that has desired solidity or rigidity.

The jogger guide 75 is fixed to the joint in the central portion of the pair of suction ducts 53 so as to connect the pair of suction ducts 53 fixed to the suction-pad supporting member 54 in the Y-axis direction. The jogger base 72 extends upward and is arranged so as to slide inside the jogger guide 75. The jogger base 72 has substantially the same function as that of the jogger. In other words, the jogger base 72 has the function of moving the medicine package 2 that has already been dispensed to a medicine dispensing tray or a subdivision box to a desired position inside the same medicine dispensing tray or subdivision box when the medicine package 2 is dispensed to a medicine dispensing tray or a subdivision box several times. As will be described later in detail, the jogger base 72 is formed by resin or light metal, such as aluminum (A1) or aluminum alloy whose weight is light, that has a desired solidity or rigidity and does not deform easily even if it contacts the medicine package 2.

As illustrated in FIG. 22A, the pair of upper and lower guide units 73 are fixed to a lower portion of the sidewall of the picking-up frame 50a in the Y-axis direction to form a guide groove 73a. The coupler 76 that extend upward has a guide pin 74 at the bottom end, and such a guide pin is fitted into the guide groove 73a formed between the pair of guide units 73 and moves along that groove. The pair of pulling springs 78 are arranged in the Y-axis direction over a predetermined range between the jogger guide 75 and the upper portion 72a of the jogger base 72. The pair of pulling springs 78 apply pulling biasing force between the jogger guide 75 and the upper portion 72a of the jogger base 72.

The rotary coupler 77 is arranged between the top end of the jogger base 72 and the top end of the coupler 76 in a predetermined range of angle and in a freely rotatable manner (in a counterclockwise (CCW) direction and clockwise (CW) direction), and serves as a joint. As illustrated in FIG. 22A, the coupler 76 is composed of a pair of vertical couplers 76a each of which has, at the bottom end, the guide pin 74 that moves inside the guide groove 73a formed between the pair of guide units 73, and a pair of horizontal couplers 76b that are coupled to each other through the rotary coupler 77 at the central portion of the jogger base 72. In the following description, the configuration of the details of the coupler 76 as described above may be referred to simply as the coupler 76.

As illustrated in FIG. 22A, the top end of one of the pair of pulling springs 78 on the left is hooked at the left end of one of the pair of horizontal couplers 76b, and the bottom end of one of the pair of pulling springs 78 on the left is hooked at the left end of the jogger guide 75. In a similar manner, the top end of the other one of the pair of pulling springs 78 on the right is hooked at the right end of the other one of the pair of horizontal couplers 76b, and the bottom end of the other one of the pair of pulling springs 78 is hooked at the right end of the jogger guide 75. Due to the configuration as described above, the jogger base 72 can be moved up and down smoothly using the pair of pulling springs 78 that expand and contract in accordance with the movement of the jogger base 72.

In the present embodiment, as indicated in FIG. 22A and FIG. 23A by virtual lines, i.e., the dot-dot-dash lines, a medicine dispensing tray 30A is arranged in place of the medicine dispensing tray 30 according to the first comparative example to the third comparative example. In the multiple rooms 33 of the medicine dispensing tray 30A according to the present embodiment indicated by dot-dot-dash lines in FIG. 22A, a notch 33a is formed as space on the sidewall facing the front plane such that the bottom end 72b or a lower portion of the jogger base 72 are made to pass through such a notch by the jogger mechanism 71.

As indicated by solid lines in FIG. 22A and FIG. 23A, the subdivision box 34A that is attachable to and detachable from a specific room of the medicine dispensing tray 30A is arranged in view of the fact that the subdivision box 34A is used at a relatively high frequency as illustrated in FIG. 3. In view of the fact that the subdivision box 34A is used at a relatively high frequency, how the medicine package 2 is dispensed to the subdivision box 34A is described below. The medicine package 2 is dispensed to a specific room of the medicine dispensing tray 30A in a similar manner to the medicine package 2 dispensed to the subdivision box 34A.

In the subdivision boxes 34A illustrated in FIG. 22A and FIG. 23A, a notch 34a is formed as space on the sidewall facing the front plane such that the bottom end 72b or a lower portion of the jogger base 72 are made to pass through such a notch by the jogger mechanism 71. The forming position and the size are approximately the same between the notch 34a of the subdivision box 34A and each of the notches 33a of the multiple rooms 33 of the medicine dispensing tray 30A.

The progression of the operation when the pickup unit 50C that has sucked and held the second medicine package 2-2 onto the pair of suction pads 52 is conveyed to a position above the subdivision box 34A that is formed with the notch 34a and is arranged on the medicine dispensing tray 30A formed with the notch 33a in a detachable manner and the second medicine package 2-2 is inserted into the subdivision box 34A is described below with reference to the FIG. 22A to FIG. 22D and FIG. 24A to FIG. 24D.

In a similar manner to the first comparative example described above with reference to FIG. 13A and FIG. 13B, when the pickup unit 50C provided with the pair of suction pads 52, which have sucked and held the second medicine package 2-2 thereto, is conveyed by the conveyor 90 to the subdivision box 34A attached to desired one of the medicine dispensing trays 30, as illustrated in FIG. 22A, FIG. 22B, and FIG. 24A, the suction device 51 and the jogger base 72 are at the initial positions. At that moment in time, the first medicine package 2-1 has already been inserted into the subdivision box 34A, and the pressure-bonded portion 4 of the adhered portions 2c of the first medicine package 2-1 contacts and leans on the interior wall 11e on the left in FIG. 22B. Under such conditions, the second medicine package 2-2 cannot orderly be inserted into the subdivision box 34A.

In order to handle such a situation, firstly, as illustrated in FIG. 22C and FIG. 24B, the drive motor 63 is driven to rotate in a similar manner to the first comparative example, and in conjunction with the movement of the pair of suction ducts 53 from their initial positions in a downward direction D together with the suction-pad supporting member 54, the bottom end 72b of the jogger base 72 enters the subdivision box 34A through the notch 34a in accordance with the movement of the jogger mechanism 71. Then, as illustrated in FIG. 22C, the bottom end 72b of the jogger base 72 contacts the pressure-bonded portion 4 of the adhered portions 2c of the first medicine package 2-1, which is leaning on the interior wall 11e of the subdivision box 34A on the left as illustrated in FIG. 22B, from the left. Then, as illustrated in FIG. 22D, the posture of the first medicine package 2-1, which is leaning on the left interior wall 11e of the subdivision box 34A, is corrected so as to contact the right interior wall 11e of the subdivision box 34A, while the pickup unit 50C is being moved by the conveying operation of the conveyor 90 in a right direction R. In other words, as the bottom end 72b of the jogger base 72 prevents the notch 34a from being blocked by the first medicine package 2-1, the second medicine package 2-2 is properly and orderly guided when it is to be inserted into the subdivision box 34A.

In the movement of the jogger mechanism 71 as illustrated in FIG. 22C and FIG. 24B, the pair of pulling springs 78 contract when the suction device 51 moves in the downward direction D through the rotation of the coupler 76 in the counterclockwise direction CCW by the rotary coupler 77, and the bottom end 72b of the jogger base 72 moves along the jogger guide 75 through the downward movement of the guide pin 74 guided to the guide groove 73a of the pair of guide units 73. Subsequently, as illustrated in FIG. 22D, FIG. 24C, and FIG. 24D, in conjunction with the operation of conveying the pickup unit 50C by the conveyor 90 in the X-axis direction, i.e., the right direction R, which is similar to the operation in the first comparative example, the bottom end 72b of the jogger base 72 makes the first medicine package 2-1 contact the right interior wall 11e of the subdivision box 34A in accordance with the movement of the jogger mechanism 71 while contacting the pressure-bonded portion 4 of the adhered portions 2c of the first medicine package 2-1 from the left. By so doing, possible troubles when the sucking and holding force applied to the second medicine package 2-2 is released as the pair of suction pads 52 apply pressure and the second medicine package 2-2 is inserted into the subdivision box 34A can be removed.

As the pair of pulling springs 78 contract, the coupler 76 moves downward, and the guide pin 74 that is guided to the guide groove 73a of the pair of guide units 73 moves further downward. As the jogger base 72 is moved in conjunction with the movement of the suction device 51 using the pair of guide units 73 and the jogger guide 75 of the jogger mechanism 71, the jogger base 72 can be moved without the need for an extra drive for the jogger base 72.

The progression of the operation of lifting the jogger base 72 after the posture of the first medicine package 2-1 inside the subdivision box 34A is corrected as illustrated in FIG. 22D and then the second medicine package 2-2 is inserted into the subdivision box 34A is described with reference to FIG. 23A to FIG. 23D and FIG. 25A to FIG. 25D where appropriate.

As illustrated in FIG. 23A to FIG. 23D and FIG. 25A to FIG. 25D, after the second medicine package 2-2 is inserted into the subdivision box 34A, the suction device 51 is moved in an upward direction U without making the jogger base 72 pass through the notch 34a of the subdivision box 34A. By so doing, the bottom end 72b of the jogger base 72 is retracted above the subdivision box 34A so as not to interfere with the first medicine package 2-1 and the second medicine package 2-2. As described above, the bottom end 72b of the jogger base 72 is retracted from the upper end of the subdivision box 34A in the upward direction U. As the bottom end 72b of the jogger base 72 is retracted in the upward direction U so as not to interfere with the subdivision box 34A when the pickup unit 50C moves, the pickup unit 50C does not disturb the movement of the subdivision box 34A.

When the suction device 51 is moved in the upward direction U, the pair of pulling springs 78 are pulled out and expanded as illustrated in FIG. 25B to FIG. 25D from the lowered position of the jogger base 72 as illustrated in FIG. 25A. Then, the jogger base 72 moves along the jogger guide 75 in the upward direction U through the rotation of the rotary coupler 77 in the clockwise direction CW, and returns to the initial position illustrated in FIG. 24A. As the jogger base 72 moves as described above, the jogger base 72 retracts to a position where it does not disturb the movement of the pickup unit 50C.

When the first medicine package 2-1 and the second medicine package 2-2 are dispensed to the subdivision box 34A, the suction device 51 has to be moved in the downward direction D. In so doing, in conjunction with the movement of the suction device 51, the jogger base 72 moves along the coupler 76 and the jogger guide 75 through the guide pin 74 guided inside the guide groove 73a of the pair of guide units 73. Due to such a configuration, the jogger base 72 can be moved without the need for an actuator to drive the jogger base 72.

The progression of the operation of the jogger mechanism 71 according to an embodiment between the instant when a pack is picked up from a container and the instant when the posture or attitude of the pack has been changed is described below with reference to FIG. 26A to FIG. 28B. The operations of elements other than the jogger mechanism 71 are similar to those according to the first comparative example.

The pair of pulling springs 78 of the jogger mechanism 71 are in a contracting state between the instant when the pair of suction pads 52 are waiting as illustrated in FIG. 26A and the instant when the medicine package 2 is separated from the container 10 as illustrated in FIG. 27B. Between those instants, the pair of suction pads 52 enter the container 10 as illustrated in FIG. 26B, the medicine package 2 is held on the inner bottom of the container 10 as illustrated in FIG. 26C, and then the medicine package 2 is separated from the container 10 as illustrated in FIG. 27A. Under these circumstances, the jogger base 72 is moved from the initial position as illustrated in FIG. 28B where the posture or attitude of the pack has already been changed.

Subsequently, as illustrated in FIG. 28A, the pair of pulling springs 78 are pulled out when the posture or attitude of the pickup unit 50C is changed to change the posture or attitude of the medicine package 2. The suction device 51 of the pickup unit 50C changes its posture or attitude while pulling the pair of pulling springs 78, and moves to a position as illustrated in FIG. 28B.

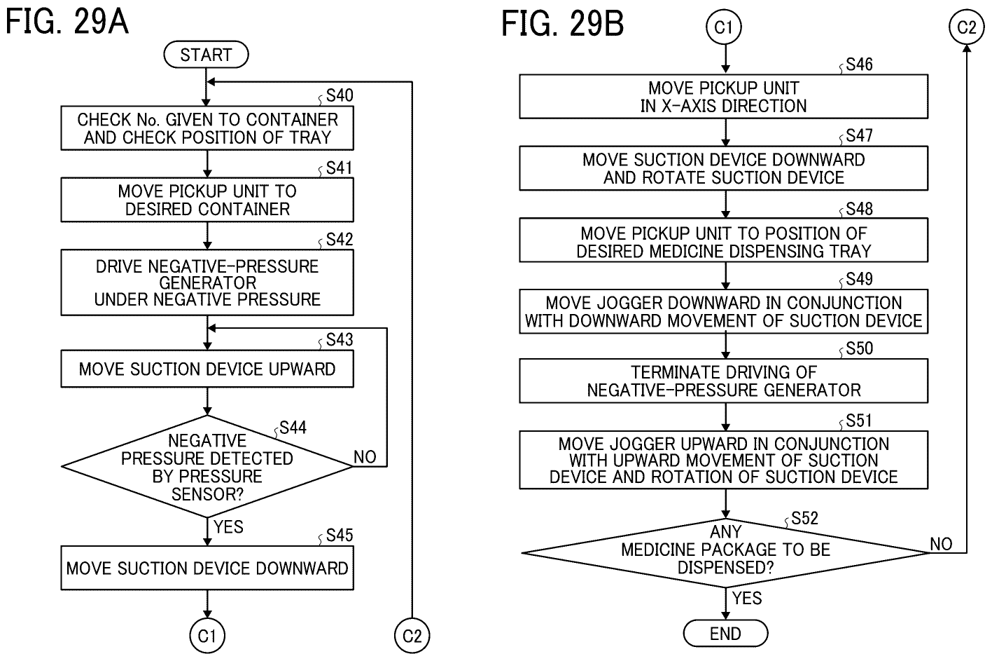

FIG. 29A and FIG. 29B are flowcharts of the operation performed by the pickup unit 50C and the jogger mechanism 71 according to the present embodiment described above with reference to FIG. 22A to FIG. 28B.

Although the configuration or structure of the present embodiment is different from that of the first comparative example as the former includes the pickup unit 50C provided with the jogger mechanism 71, the operations in steps S40 to S45 are equivalent to the operations in steps S10 to S15 according to the first comparative example described with reference to FIG. 18A and FIG. 18B.

After the suction device 51 is moved downward in step S45, in step S46, the pickup unit 50C is moved in the X-axis direction, and desired one of the multiple medicine packages 2 is completely taken out from one of the multiple containers 10. Then, in step S47, the drive motor 63 is further driven to rotate in the reverse direction so as to move the suction device 51 downward. As a result, the suction device 51 is rotated by approximately 90 degrees, and the posture of the medicine package 2 is changed from an approximately parallel or horizontal posture to an approximately vertical posture. Subsequently, in step S48, the pickup unit 50C is moved to a desired position of one of the multiple medicine dispensing trays 30 by the conveyor 90.

After the pickup unit 50C is moved to the position of desired one of the medicine dispensing trays 30, the suction device 51 is moved slightly downward. In so doing, as illustrated in FIG. 22C, the guide pin 74 moves along the guide groove 73a between the pair of guide units 73. In conjunction with this movement, in step S49, the bottom end 72b of the jogger base 72 moves downward. Accordingly, the bottom end 72b of the jogger base 72 contacts the pressure-bonded portion 4 of the adhered portions 2c of the first medicine package 2-1, and the first medicine package 2-1 contacts the right interior wall 11e of the subdivision box 34A.

Subsequently, the pickup unit 50C is moved to a position as illustrated in FIG. 22D, and in step S50, the operation of the negative-pressure generator 45 is switched to terminate generating negative pressure and start generating positive pressure. By so doing, the second medicine package 2-2 is separated from the pair of suction pads 52 and is inserted into the subdivision box 34A. As the pressure-bonded portion 4 of the adhered portions 2c of the first medicine package 2-1 contacts the right interior wall 11e of the subdivision box 34A, even if the sucking and holding force applied to the second medicine package 2-2 is released as the pair of suction pads 52 apply pressure, possible troubles when the second medicine package 2-2 is separated from the pair of suction pads 52 and is inserted into the subdivision box 34A can be removed.

In step S51, the suction device 51 moves upward, and in conjunction with that movement, the bottom end 72b of the jogger base 72 moves upward as illustrated in FIG. 23C and FIG. 23D. Together with that, the suction device 51 returns to the initial position. Then, in step S52, whether there is any medicine package 2 to be dispensed is checked. When there is no medicine package 2 to be dispersed, a series of operations is terminated. On the other hand, when it is determined in the step S52 that there is at least one medicine package 2 to be dispersed, the process is returned to the step S40, and the same series of processes in the above steps are repeated.

According to the present embodiment as described above, even if a medicine package to be dispensed has already been dispensed to a room of the same medicine dispensing tray or the subdivision box that corresponds to that room, the jogger base 72 of the jogger mechanism 71 moves the medicine package to a predetermined position of a room of the same medicine dispensing tray or the subdivision box that corresponds to that room. Due to such a configuration, space for dispensing medicine is secured. In other words, when medicines are to be dispensed, for example, the interferes with a pack that has already been dispensed to a room of the same medicine dispensing tray or the subdivision box that corresponds to that room are avoided.

Moreover, medicines are dispensed in such a manner that the pack to be dispensed next does not interfere with the pack that has already been dispensed to a room or subdivision box of the medicine dispensing container, and the time for the operation of binding multiple packs to be dispensed, using, for example, a stapler, can be reduced.

In the present embodiment, the jogger base 72 of the jogger mechanism 71 is arranged at the suction device 51 of the pickup unit 50C. However, no limitation is intended thereby, and for example, the jogger base 72 of the jogger mechanism 71 may be arranged at the suction device 51 of the pickup unit 50B according to the second comparative example as described above with reference to FIG. 19A and FIG. 19B. In other words, the jogger base 72 may be operated in a similar manner to the above embodiment in conjunction with the up-and-down movement of the suction device 51 by driving the drive motor 63 to rotate and the operation of changing the angle of the suction device 51 by driving the suction device angle changing motor 70 to rotate.

The above embodiments of the present disclosure described above substantially include, for example, the following aspects.

### First Aspect

A medication support device includes a container such as the container 10 that stores a medicine package such as the medicine package 2, a pickup device such as the pickup unit 50C to pick up the medicine package from the container, a suction device such as the suction device 51 disposed at the pickup device to suck the medicine package in the container by air, a conveyor such as the conveyor 90 to convey the medicine package picked up from the container using the suction device, a medicine dispensing container such as the medicine dispensing tray 30A to dispense the medicine package conveyed by the conveyor at a specific one of a plurality of positions partitioned by a plurality of partitions, and a jogger such as the jogger mechanism 71 provided with, for example, the jogger base 72 to move the medicine package that has already been dispensed to the medicine dispensing container to a desired position of the same medicine dispensing container when the medicine package is dispensed from the container to the medicine dispensing container a plurality of times.

According to the first aspect, even if a medicine package to be dispensed has already been dispensed to the same medicine dispensing tray, the jogger moves the medicine package to a predetermined position of the same medicine dispensing container. Due to such a configuration, space for dispensing medicine is secured. Moreover, the time for the operation of binding multiple medicine packages to be dispensed, using, for example, a stapler, can be reduced.

### Second Aspect

In the first aspect, the medicine dispensing container includes a plurality of rooms such as the rooms 33 partitioned by a plurality of partitions, and includes a box such as the subdivision box 34A that is attachable to and detachable from each one of the plurality of rooms. Moreover, before the medicine package to be dispensed is inserted into one of the plurality of rooms or the box corresponding to the one of the plurality of rooms, the jogger moves the medicine package that has already been dispensed to the one of the plurality of rooms or the box corresponding to the one of the plurality of rooms to the desired position of the one of the plurality of room or the box corresponding to the one of the plurality of rooms.

According to the second aspect, when medicines are to be dispensed, interference with the medicine package that has already been dispensed to a room or a box can be avoided.

### Third Aspect

In the first or second aspect, the jogger is retracted when the jogger is not used.

According to the third aspect, interference with, for example, a frame can be avoided in transit so as not to disturb conveyance or transportation.

### Fourth Aspect

In any one of the first to third aspects, the jogger is disposed at the suction device.

According to the fourth aspect, even if multiple medicine dispensing containers are used, it is not necessary to increase the number of joggers.

### Fifth Aspect

In any one of the first to fourth aspects, the jogger operates in conjunction with movement of the suction device.

According to the fifth aspect, it is not necessary to arrange an actuator for driving the jogger.

### Sixth Aspect

In any one of the first to fifth aspects, the medicine dispensing container has space in which the jogger moves.

According to the sixth aspect, the medicine dispensing container does not disturb the movement of the jogger even when the medicine dispensing container has a relatively small thickness or the medicine package is short in height, and the first medicine package can be moved to a desired position with reliability.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application-specific integrated circuit (ASIC), digital signal processor (DSP), field-programmable gate array (FPGA), and conventional circuit components arranged to perform the recited functions.

What is claimed is:

1. A medication support device comprising:
a container that stores a medicine package;
a pickup device to pick up the medicine package from the container;
a suction device disposed at the pickup device to suck the medicine package in the container by air;
a conveyor to convey the medicine package picked up from the container using the suction device;
a medicine dispensing container to dispense the medicine package conveyed by the conveyor at a specific one of a plurality of positions partitioned by a plurality of partitions; and
a jogger to move the medicine package that has already been dispensed to the medicine dispensing container to a desired position of the medicine dispensing container when the medicine package is dispensed from the container to the medicine dispensing container a plurality of times.

2. The medication support device according to claim 1,
wherein the medicine dispensing container includes a plurality of rooms partitioned by the plurality of partitions and includes a box attachable to and detachable from each one of the plurality of rooms, and
wherein, before the medicine package to be dispensed is inserted into one of the plurality of rooms or the box corresponding to the one of the plurality of rooms, the jogger moves the medicine package that has already been dispensed to the one of the plurality of rooms or the box corresponding to the one of the plurality of rooms to the desired position of the one of the plurality of rooms or the box corresponding to the one of the plurality of rooms.

3. The medication support device according to claim 1,
wherein the jogger is retracted when the jogger is not used.

4. The medication support device according to claim 1,
wherein the jogger is disposed at the suction device.

5. The medication support device according to claim 1,
wherein the jogger operates in conjunction with movement of the suction device.

6. The medication support device according to claim 1,
wherein the medicine dispensing container has space in which the jogger moves.
